(19) United States
(12) Patent Application Publication
(10) Pub. No.: US 2017/0024685 A1
(43) Pub. Date: Jan. 26, 2017

(54) SYSTEMS AND METHODS FOR INTELLIGENT OBJECT TRANSMISSION

(71) Applicant: Aldo DiSorbo, Davie, FL (US)

(72) Inventor: Aldo DiSorbo, Davie, FL (US)

(21) Appl. No.: 14/825,283

(22) Filed: Aug. 13, 2015

Related U.S. Application Data
(60) Provisional application No. 62/059,961, filed on Oct. 5, 2014.

(51) Int. Cl. G06Q 10/08

(52) U.S. Cl. CPC G06Q 10/083

(57) ABSTRACT

A method for actuating movement of items from a source location to a destination location, comprising: (a) ascertaining a move initiating entity having a source location; (b) identifying a first set of components at the source location, and iteratively processing each component in the set of components by performing the following steps until each component from the set of components is processed; (1) identifying a next component from the set of components, and (2) iteratively generating a tag for the next component; (c) selecting a first set of items from the tagged items at the source location, and generating a destination layout at the source location via an interface based on an input; (d) ascertaining a set of distance parameters for the source location and the destination location, and generating at least one estimate for moving the first set of items from the source location to the destination location.

### BACKGROUND

1. Field of Disclosure

The present invention relates to systems and methods for actuating movement of at least one object from a source location to a destination location. More particularly, the invention relates to the use of a communication device to rapidly and accurately record video and audio documentation of objects to be moved from the source location to the destination location, and transmitting that documentation to a moving company in order to create an inventory list, and moving cost estimation.

2. Brief Description of Related Art

Scheduling a moving company (i.e., an entity which transports items belonging to a person or business from one location to another) to conduct a move (i.e., a project which includes, but is not necessarily limited to, the transportation of items (e.g., furniture, appliances, belongings and the like) from one or more source locations to one or more destination locations, such as from a residence or business at one location to a residence or business at another location) is a time-consuming process. For example, to coordinate a residential move, a consumer may typically contact about two to five moving companies via a telephone call, and may spend a significant amount of time on the phone with each to describe what is to be moved.

Alternatively, the consumer may request a moving company to visit the consumer's residence to provide an in-home estimate, requiring that the consumer set aside time, often during weekdays and working hours, to meet the representative of the moving company at the consumer's residence. On average, the entire process of the consumer making an initial contact with the moving company and the consumer receiving a moving cost estimate may typically take several days.

It is a common practice in the commercial moving industry to provide price quotes for moving household or commercial goods. An accurate inventory of all items to be moved from the source location to the destination location is required for generating a fair price quote. Generally, an inventory may be created by ascertaining the number of items to be moved, the description of each of the number of items to be moved. Subsequently, a price quote may be generated using the industry standards to calculate the total weight and/or volume of the items and after considering other parameters such as the distance between the source location and the destination location, the mode of transportation, climatic conditions, and the like.

Inventories may be created on-site by a representative of the moving company using a manual system known as a “cube sheet.” Alternatively, a representative of a moving company may take inventories over the telephone by interviewing the consumer and completing a manual cube sheet remotely. This method may be subject to calculation errors and may not generate a legible printed inventory for verification or audit purposes. Without a printed inventory, it may be difficult for either the consumer or the moving company to audit the contents of the move to determine if all the items to be moved from the source location to the destination location were included in the price quote provided by the moving company.

Consumer created inventories may often be unreliable because of the tendency of the consumer to underestimate the items to be moved or to omit items from the list of items to be moved. Furthermore, a discrepancy may exist between the consumer and the moving company about names or descriptions of certain items, for example, a large overstuffed living room armchair may be identified as a chair, and a dining room chair may also be designated as a chair by the consumer. In reality, the two chairs may be treated differently by the moving company since dining room chair may be lighter than the armchair and can be stacked during the transportation. In other words, a small TV stand, an entertainment unit, and a fragile art work may be treated differently by the moving company because of their fragility, weight and volume.

Traditional moving systems can be disadvantageous for both the moving company as well as the consumer. For example, when a consumer desires to transport some items to a destination location and other items to a storage facility, there may be some confusion in the consumer's mind as to which items are to be transported at which location. Thus, a shipment can increase in size and volume when the consumer moves items from the shipment to storage location to the shipment to destination location. This type of shift may cause burden on the moving company.

Likewise, consumers must guard against “bumping” of the weight of a shipment by an unscrupulous moving company where the price is based on an agreed price per pound. It would be advantageous to have a system which permits an audit process to verify the scaled weight against the estimated weight.

From the consumer's perspective, conducting a move is far more than transporting items from a source location to a destination location. Moving may usually indicate establishing a new place of residence, which may in addition to moving items to a destination location include determining a place for each transported item at the destination location, and starting a set of services at the destination location, such as phone, cable, utility, electricity, water services and the like. Furthermore, moving heavy furniture at the destination location can be a challenge nonetheless. Even though consumers may typically have a rough idea as to where the transported items are going to be placed at the destination location, traditional moving systems do not provide a means for detailed planning a layout of transported items at the destination location.

Therefore, there is a need in the art for a method and system of creating an inventory of goods to be moved while automatically calculating the volume and weight of the goods which mitigates the difficulties of the conventional moving systems. It would be advantageous if such a method and system permitted a consumer to create and verify an inventory, and define a destination layout holding the transported items.

### BRIEF SUMMARY

By way of introduction only, the present embodiments provide methods and systems for actuating movement of at least one item from a source location to a destination location, the method comprising: ascertaining a move initiating entity having a source location, identifying a first set of components at the source location, and iteratively processing each component in the set of components at the source location by performing the following steps until each component from the set of components is processed (1) identifying a next component from the set of components, and (2) iteratively generating a tag for the next component. The method further comprises the steps of selecting a first set of items from the tagged items at the source location, wherein the first set of items is to be dispatched from the source location to the destination location, and generating a destination layout at the source location via an interface based on an input specifying a desired position of each item in the first set of items at the destination location. Furthermore, the method may comprise the steps of ascertaining a set of distance parameters for the source location and the destination location, and generating at least one estimate for moving the first set of items from the source location to the destination location after performing a first set of calculations.

Further, the input specifying the desired position of each item in the first set of items at the destination location may be provided by the move initiating entity. Likewise, the method comprises the steps of: (1) generating a source layout indicating the position of each item in the set of items at the source location (2) generating a three dimensional model of the source layout and a three dimensional model of the destination layout on the interface (3) selecting an item from the first set of items from the three dimensional model of the source layout and situating the selected item in the three dimensional model of the destination layout (4) selecting each item from the first set of items from the three dimensional model of the source layout and situating the selected each item in the three dimensional model of the destination layout (5) mapping the location of each item in the first set of items from the three dimensional model of the source layout to a corresponding location on the three dimensional model of the destination layout, such that each item in the first set of items from the source layout has a corresponding position on the three dimensional model of the destination layout (6) ascertaining a number of boxes required to accommodate the first set of items (7) configuring the contents of a given box by grouping items of varying sizes and orientations from the first set of items such that least amount of empty space is left in the given box (8) connecting at least one consumer service at the destination location upon receiving a request to connect the consumer service from the move initiating entity (9) transporting a consumer vehicle at the destination location upon receiving a request to transport the consumer vehicle from the move initiating entity (10) transporting a second set of items from the tagged items from the source location to a storage facility upon receiving a request to transport the second set of items to the storage facility from the move initiating entity, and (11) generating at least one estimate based on at least one of the set of distance parameters for the source location, the set of distance parameters for the destination location, and the distance between the source location and the destination location. The term “three dimensional model” may include a three-dimensional rendering and it may be in a computing device (such as, but not limited to, an Ipad®, desktop computer, smartphone, etc.).

Further, the first set of calculations may comprise the step of calculating the distance between the source location and the destination location and wherein the first set of calculations further comprises the steps of aggregating the cost of the number of boxes required for packing the tagged items, the cost of packing the tagged items, the cost of moving the tagged items from the source location to the destination location, the cost of transporting the consumer vehicle from the source location to the destination location, and the cost of connecting the services at the destination location. Furthermore, the set of distance parameters for the source location may comprise the distance between the source location and the source loading zone, and wherein the set of distance parameters for the destination location comprise the distance between the destination location and the destination loading zone.

By way of introduction only, the present embodiments provide systems for actuating movement of at least one item from a source location to a destination location, the system comprising a control unit configured to ascertain a move initiating entity and identify a first set of components at the source location, a component processing unit configured to iteratively process each component in the set of components at the source location until each component from the set of components is processed, the component processing unit comprising: an identification unit configured to identify a next component from the first set of components, and a tag generation unit configured to generate a tag for the next component, a selection unit configured to select a first set of items from the tagged items at the source location, wherein the first set of items is to be dispatched from the source location to the destination location.

The disclosed system also comprises a destination layout generation unit configured to generate a destination layout at the source location via an interface based on an input specifying a desired position of each item in the first set of items at the destination location, a distance computation unit configured to ascertain a set of distance parameters for the source location and the destination location, and an estimate generation unit configured to generate at least one estimate for moving the first set of items from the source location to the destination location after performing a first set of calculations.

Accordingly, the primary object of the present invention is to provide a means to quickly and efficiently move objects from one location to another. It is accordingly an object of the present invention to provide a system, method, and devices for cataloging the objects being moved from one location to another. It is another object of the present invention to provide a system and method for generating various documentation and tasks accompanying a move, such as changing address at the post office and utility companies, and obtaining insurance for the move, may be incorporated into the system. It is an additional object of the invention to provide a system and method for communicating collected information to a merge processor.

It is a further object of the invention to provide a means for recording every object to be moved, as well as cataloging and describing the object according to location, category, weight, dimensions, fragility/durability, replacement cost and other factors relevant to a move. It is yet another object of the invention to provide a system and method for generating a three dimensional model of the source location and the destination location and situating the items from the source location to the destination location. Other objects, features and advantages of the present invention will become apparent upon reading the rest of this document.

Persons skilled in the art will recognize that the present invention may be used with numerous types of transmission systems. For instance, the method or system of the present invention can be deployed on an interactive space optimization system or modified for use with a conventional telephone network, a cellular network, a wireless network, or a cable network.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF SEVERAL VIEWS OF THE DRAWINGS

FIG. 1 illustrates a main menu interface according to one embodiment of the system of the disclosed invention;

FIGS. 2-7 show various interfaces that may be displayed upon consumer selecting take a tour option 104 in FIG. 1;

FIG. 8. depicts an exemplary sign-in interface of the disclosed system;

FIG. 9 shows create an estimation interface 900 displayed upon the consumer selecting create an estimate option 108 in FIG. 1 or 702 on FIG. 7;

FIG. 10 shows interface 1000 which may be displayed upon the consumer selecting order boxes option 110 in FIG. 1;

FIG. 11 shows interface 1100 that may be displayed upon the consumer selecting moving checklist option 112 in FIG. 1;

FIG. 12 shows interface 1200 that may be displayed upon the consumer selecting start your estimate option 702 on interface 700 shown in FIG. 7 or option 108 in FIG. 1;

FIG. 13 shows interface 1300 displayed upon the consumer selecting create an estimate option 902, on interface 900 shown in FIG. 9;

FIG. 14 shows move name assignment interface according to the preferred embodiment of the disclosed invention;

FIG. 15 illustrating a move date selection interface according to the preferred embodiment of the disclosed invention;

FIG. 16 showing the source location information submission interface 1600 of the disclosed invention;

FIG. 17 depicts the source location type submission interface 1700 of the disclosed invention;

FIG. 18 illustrates depicts the source home information submission interface 1800 of the disclosed invention;

FIG. 19 displays a destination location information submission interface 1900 according one embodiment of the disclosed invention;

FIG. 20 shows destination location type submission interface 2000 of the disclosed invention;

FIG. 21 illustrates the destination home information submission interface 2100 of the disclosed invention;

FIG. 22 illustrates start consumer walkthrough interface 2200 of the disclosed invention;

FIG. 23-26 illustrate various instructions for capturing images and video recording of the items to be moved to the source location according to an embodiment of the disclosed invention;

FIG. 27 shows a room type selection interface 2700 of the disclosed system;

FIG. 28 shows camera access request interface 2800 of the disclosed system;

FIG. 29 shows previously added rooms along with an option to add another room on interface 2900 of the disclosed system;

FIG. 30 shows a packing outsourcing option selection interface 3000 of the disclosed system;

FIG. 31 depicts a corporate relocation request submission interface 3100 of the disclosed system;

FIG. 32 shows an estimate review interface 3200 of the disclosed system displaying add auto move option;

FIG. 33 depicts estimation dispatch notification interface 3300 of the disclosed system showing show estimate number, click to call company and add home services showing options;

FIG. 34 illustrates home services selection interface 3400 of the disclosed invention;

FIG. 35 shows a home services information submission notification interface 3500 of the disclosed system showing click to call company option;

FIG. 36 illustrates an estimate review interface 3600 of the disclosed system;

FIG. 37 depicts a consumer information update interface 3700 according to a preferred embodiment of the disclosed invention;

FIG. 38 illustrates the source location apartment information submission interface 3800 of the disclosed invention;

FIG. 39 illustrates the source location storage facility information submission interface 3900 of the disclosed invention;

FIG. 40 depicts storage requirement submission interface 4000 of the disclosed invention;

FIG. 41 illustrates automobile information submission interface 4100 of the disclosed invention;

FIG. 42 illustrates additional pickup information submission interface 4200 of the disclosed invention;

FIG. 43 depicts request interface 4300 of the disclosed invention showing pack material request option;

FIG. 44 depicts company information submission interface 4400 of the disclosed invention if corporate relocation option is selected;

FIG. 45 illustrates additional delivery information submission interface 4500 of the disclosed invention;

FIG. 46 illustrates claim submission interface of the disclosed invention;

FIG. 47 illustrates complaint submission interface of the disclosed invention; and

FIG. 48 illustrates survey submission interface of the disclosed invention.

### DETAILED DESCRIPTION OF THE PRESENTLY PREFERRED EMBODIMENTS

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. The present invention provides a system, method and apparatus for efficiently creating an accurate inventory of items being shipped or transported from one location to another. Items to be transported and included as part of the inventory may be quickly captured and identified in still images and/or video images and/or audio file.

In one embodiment, the invention comprises a software application for a smart phone, tablet, or other device having a camera and/or video camera and/or microphone. A consumer may start by providing basic information such as consumer's name, address, email and other contact information. Further, consumer may designate the particular moving project at hand. The consumer then may stand a room with a video camera component of the device. While scanning the room containing the items which are to be transported, consumer may provide audio dialogue to accompany the video. Optionally, consumer may record a still image of each item being transported, by simply tapping the smart phone as the video camera pans over various items. Consumer may scan a single room at a time, creating video, audio and still images recording the various items in the single room. Optionally, consumer may travel through the entire house, office or other location, cataloging items in each room in the house.

When photo shoot is completed, the consumer may look through the still images and categorize each item in a category from the set of categories. The set of categories may include tables, chairs, sofas, desks, paintings, appliances, and the like. This catalog may be transmitted to an employee of a moving company. The employee may verify all of the items cataloged by the consumer, and use an algorithm or computer software to calculate the cost of the move and provide a quote to the consumer. The algorithm or software used by the employee may include a database of specific furniture items and associated costs of transportation. Optionally, software may be used with the still images and/or the video to calculate the dimensions of the various items cataloged. The software may calculate the volume and the weight to be transported from the source location to the destination location. This may provide a more accurate means of providing a quote for moving the catalogued items from the source location to the destination location. Optionally, the consumer may include a device such as a ruler or yardstick in the video and/or still shots in order to provide appropriate scale to allow calculation of dimensions of all items in the catalogue.

The use of this invention may obviate the need for an employee to visit a home or office in order to provide an accurate quote. The invention may also allow a consumer to catalog and document the items which are to be moved at any time of day or night, and allow the moving company employee to review the information and generate a quote at any time of day or night. This may improve the efficiency and ease of transportation. The system according to one embodiment of the system of the disclosed invention may help the consumer in itemizing the contents of the move. In other words, the system may help the consumer to precisely identify which items are to be moved from the source location to the destination location. Advantageously the system may be able to first identify the items that are to be moved from the source location to the destination location, conduct a weight volume, fragility based analysis of the identified items and generate an estimate for the move. If the estimated/quoted price is acceptable to the client, then the client can select book my move option and the system may notify the booking company to call the client to get payment information from the client over the phone. Alternatively, the client may be able to enter credit card information to via a payment interface to reserve the move.

During operation, consumer may optionally categorize objects according to room in which the object is located. This may simplify unloading of the objects when a destination is reached. In addition, the application may automatically transcribe the category and/or description of an object, while the video and/or still images are recorded. For example, the consumer may type or say “living room” and begin scanning the objects. When a chair comes into view of the video camera, the consumer may tap the screen to record a still image and may say “chair”. The application may then use voice to text program to record the type of object in the image.

Those skilled in the art will appreciate that the method of the invention may also be utilized to provide insurance for items during transportation or after transportation is complete and items are placed at the destination location. Optionally, the camera used may only be used to take still shots, and may not be used for recording video input. Further, consumer may optionally provide dimension and/or weight of the items to be moved from the source location to the destination location.

Optionally, the disclosed system may allow consumer to select a category and type of item being recorded from a database. It may be preferable to use both video recording and still shots of the items for improving accuracy of the cataloguing process. Thus, a moving company employee may have an opportunity to verify whether or not a given item is intended to be moved to the destination location. For example, if video recording indicates that no still shot have been taken for any items in a room however, a description exists for several items in the room, a moving company employee may communicate with the consumer to verify whether the omission was intentional or accidental.

Optionally, change of address and other routine activities coinciding with a move may be integrated into the disclosed system. For example, the consumer may indicate items which are to be moved, source and destination addresses, desired moving date and the like. This information may allow the disclosed system to automatically generate a change of address notice for the postal office. Likewise the disclosed system may automatically generate end of existing service and initiation of new service documentation for the relevant electric company, cable company, Internet company, and other service carriers requiring notification incidental to a family move or a business move.

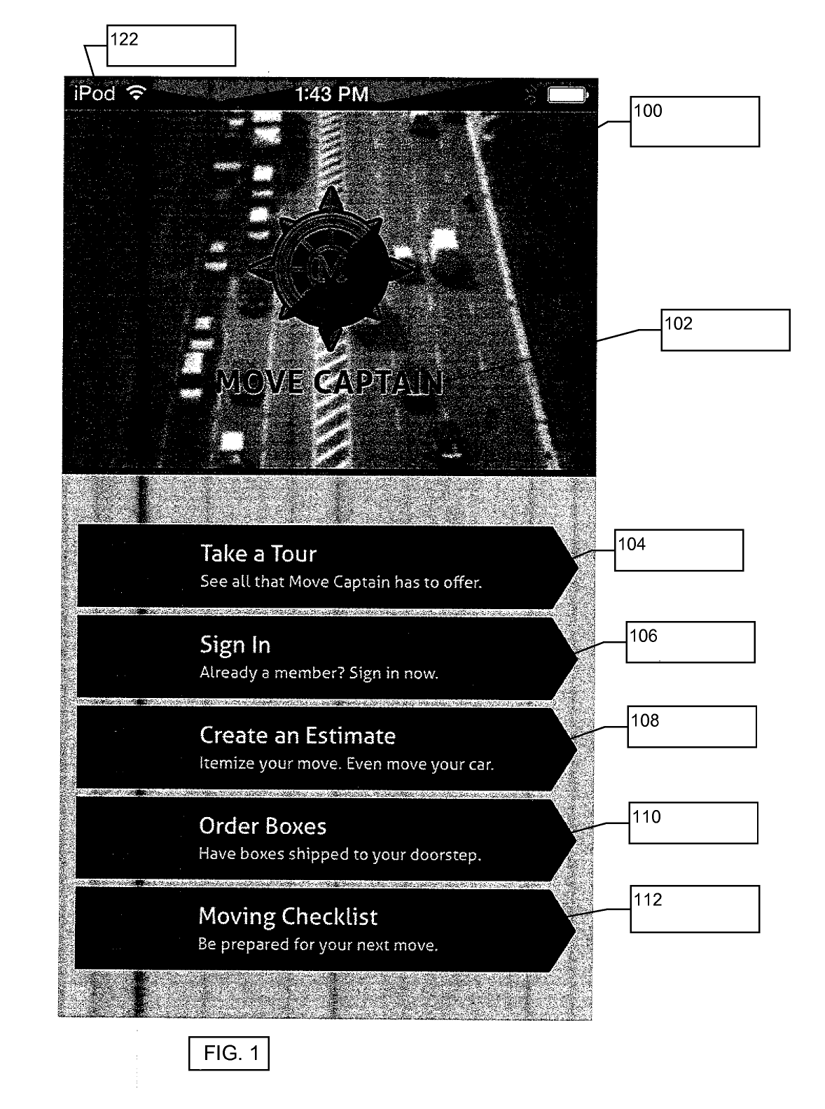

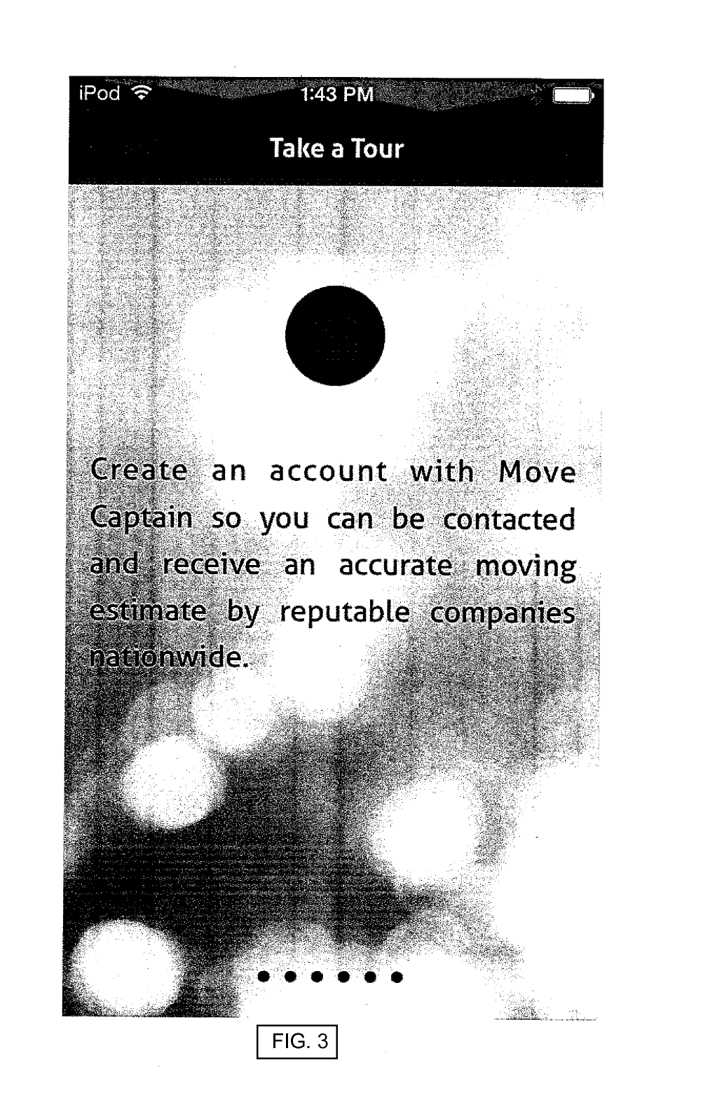

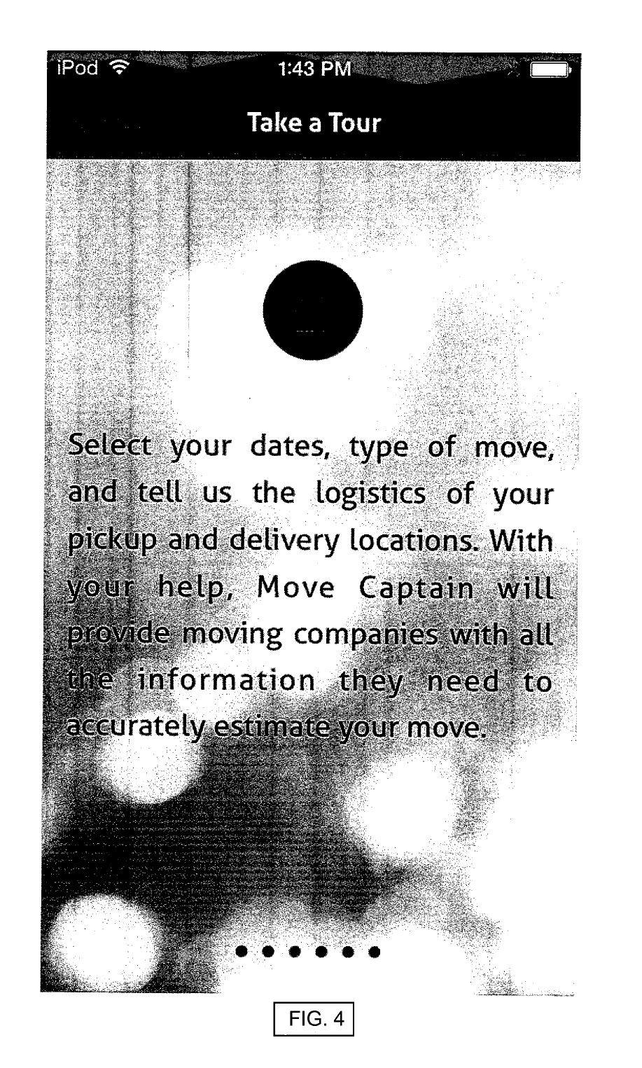

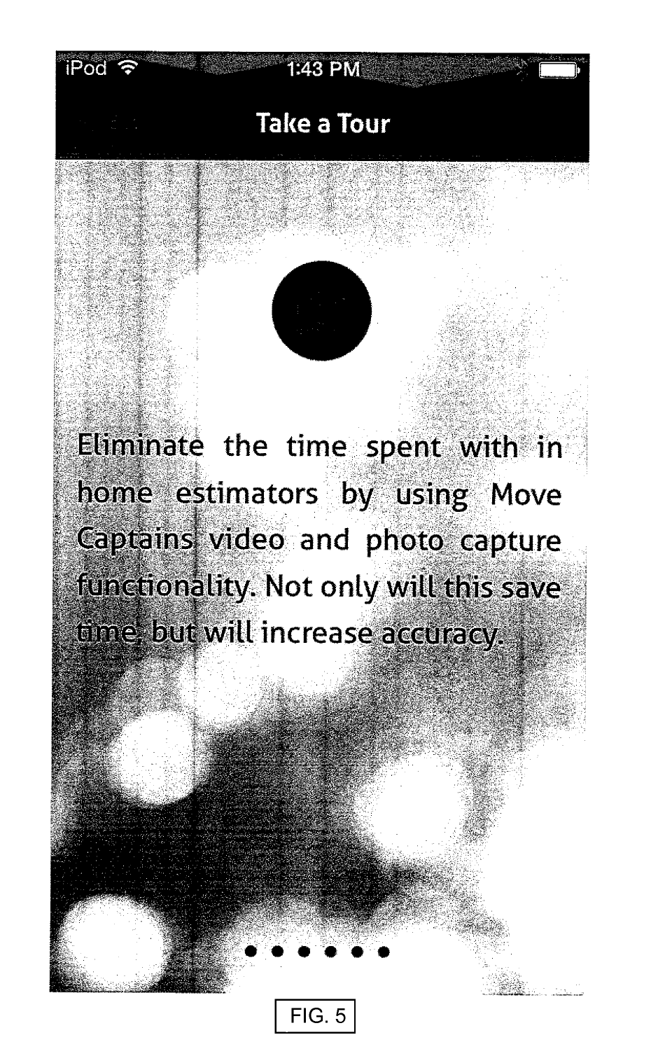

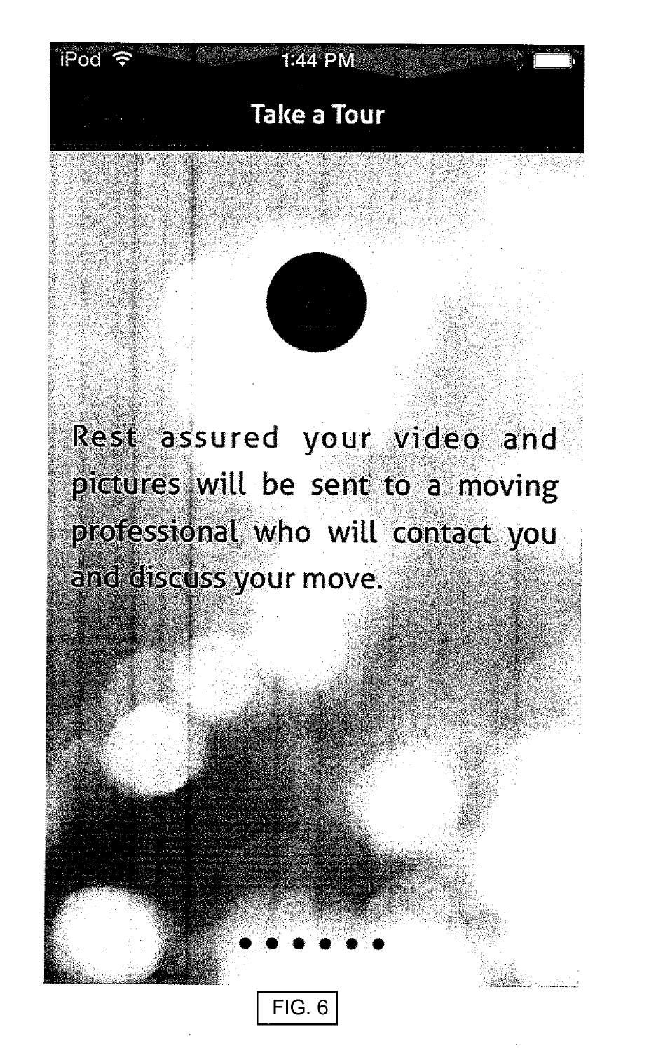

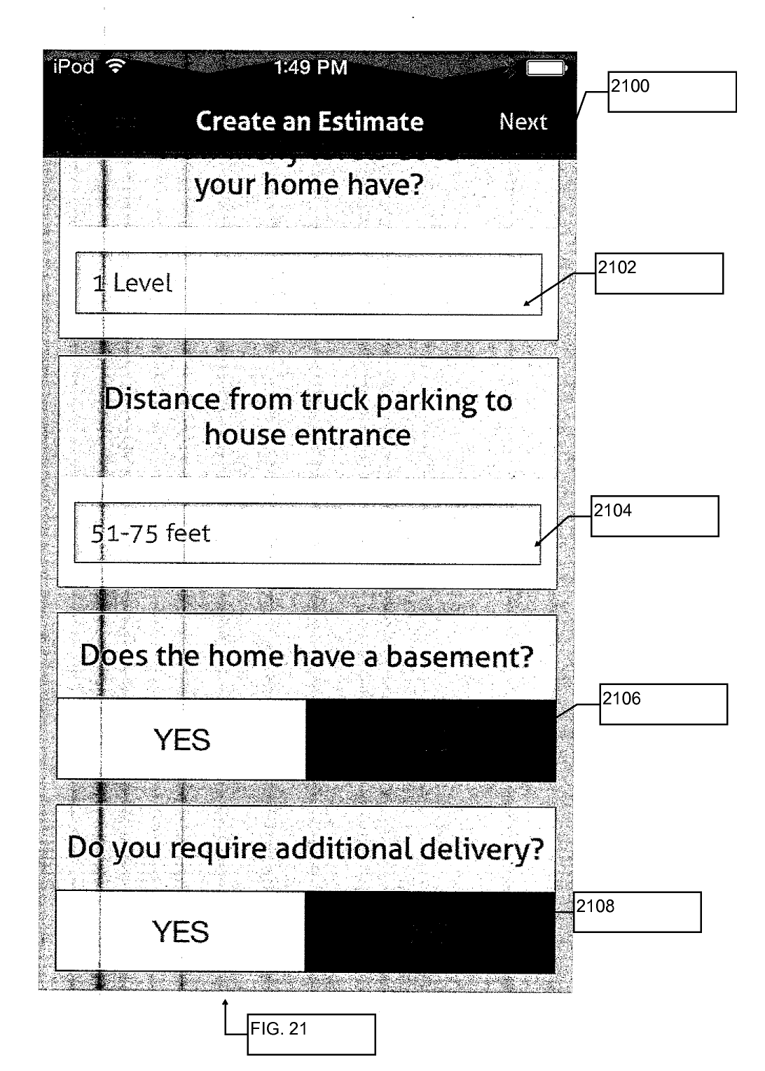

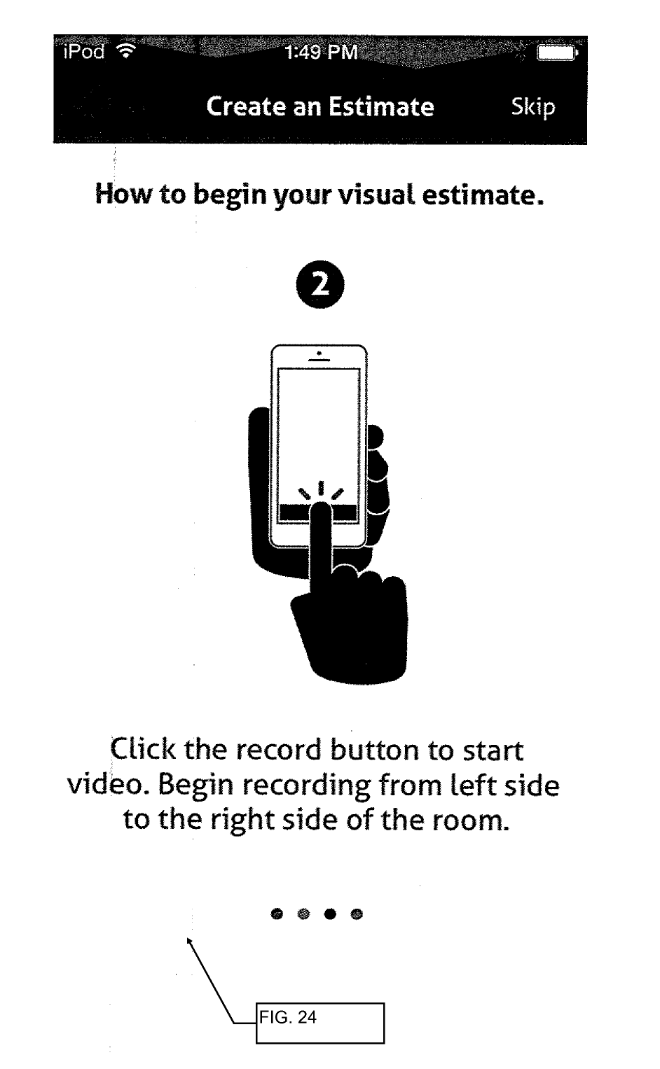

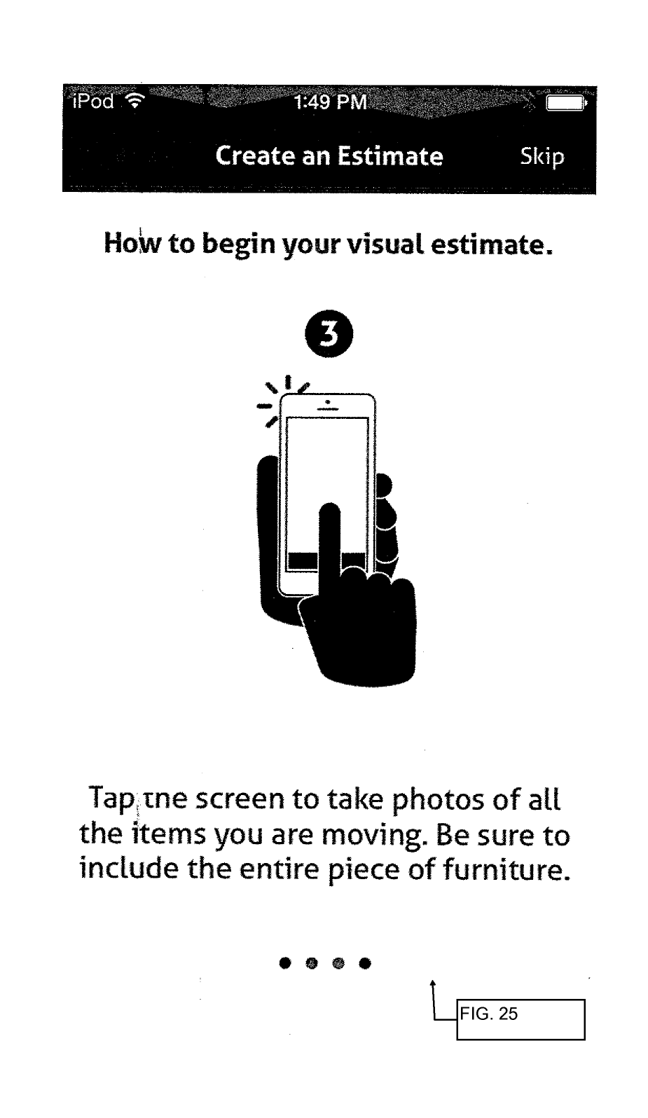

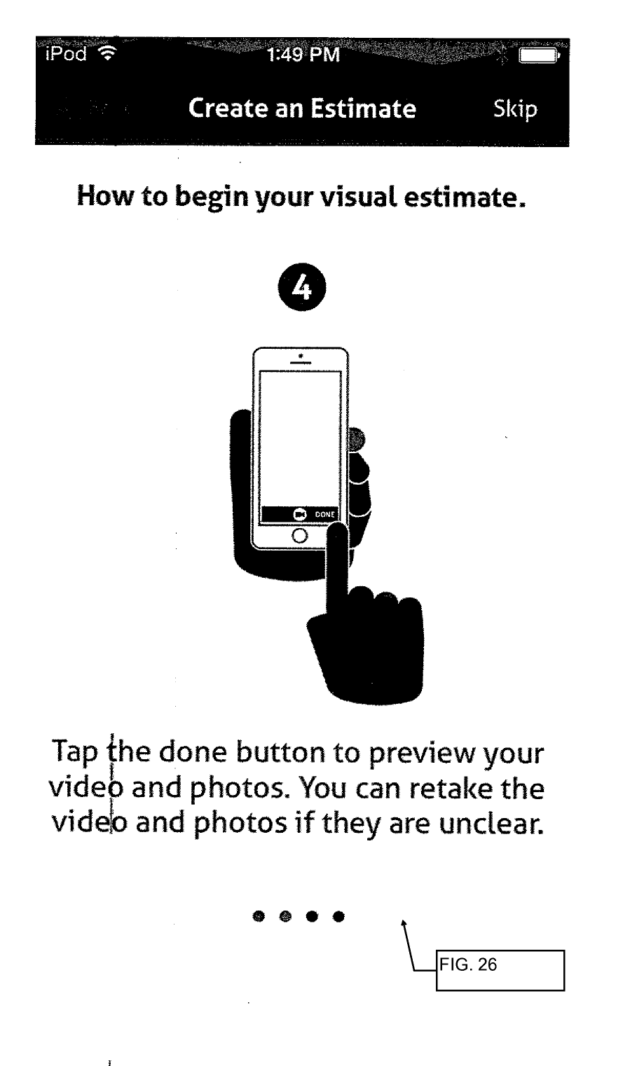

FIGS. 1-45 and descriptions of the FIGS. 1-45 together provide a list of functions and exemplary phone application screens coinciding with several aspects of the disclosed invention. Whereas, the present invention has been described in relation to the drawings attached hereto, it should be understood that other and further modifications, apart from those shown or suggested herein, may be made within the spirit and scope of this invention. Descriptions of the embodiments shown in the drawings should not be construed as limiting or defining the ordinary and plain meanings of the terms of the claims unless such is explicitly indicated.

Optionally, the information gathered by the disclosed invention may be stored on a cloud and other persons, such as a moving company employee, may be given access to the cloud. This may simplify the process and allow more data to be used without overloading various computer systems.

As such, those skilled in the art will appreciate that the conception, upon which this disclosure is based, may readily be utilized as a basis for designing other structures, methods and systems for carrying out the several purposes of the present invention. It is important, therefore, that the claims be regarded as including such equivalent constructions insofar as they do not depart from the spirit and scope of the present invention.

A more complete understanding of the present invention, and the attendant advantages and features thereof, will be more readily understood by reference to the following detailed description when considered in conjunction with the accompanying drawings, wherein FIGS. 1-45 located after the step by step description, are representations of screens provided by a software application for use with a smart phone or tablet which guide an consumer through the system and method.

By way of introduction only, the present embodiments provide methods and systems for actuating movement of at least one item from a source location to a destination location, the system comprises a control unit configured to ascertain a move initiating entity and identify a first set of components at the source location, a component processing unit configured to iteratively process each component in the set of components at the source location until each component from the set of components is processed, the component processing unit comprises: an identification unit configured to identify a next component from the first set of components, and a tag generation unit configured to generate a tag for the next component, a selection unit configured to select a first set of items from the tagged items at the source location, wherein the first set of items is to be dispatched from the source location to the destination location.

The disclosed system also comprises a destination layout generation unit configured to generate a destination layout at the source location via an interface based on an input specifying a desired position of each item in the first set of items at the destination location, a distance computation unit configured to ascertain a set of distance parameters for the source location and the destination location, and an estimate generation unit configured to generate at least one estimate for moving the first set of items from the source location to the destination location after performing a first set of calculations.

Now referring to FIG. 1 illustrating main menu interface 100 according to one embodiment of the system of the disclosed invention. The “source location” parameter defines a starting location where the consumer is located at present. The “destination location” parameter defines a location, other than the source location, where the consumer is seeking to move in the near future. In FIGS. 1-45 a name “Move Captain” indicates one embodiment of the system of the disclosed invention. Note that the interfaces described in this application are exemplary interfaces. As such, many other components may be added or taken out of the interfaces to accomplish the desired effect. Accordingly, any name other than “Move Captain” may be selected for interfaces shown in FIGS. 1-45. The interface 100 may be displayed on a computing device 122 of a consumer upon the consumer launching the Move Captain application, a logo 102 indicating name “Move Captain” may be displayed at the top of the interface 100 just above a menu item 104 displaying “take a tour” option. Alternatively, the consumer may create an estimate for an upcoming move, order boxes, or view a moving checklist by selecting options 108, 110, and 112 respectively.

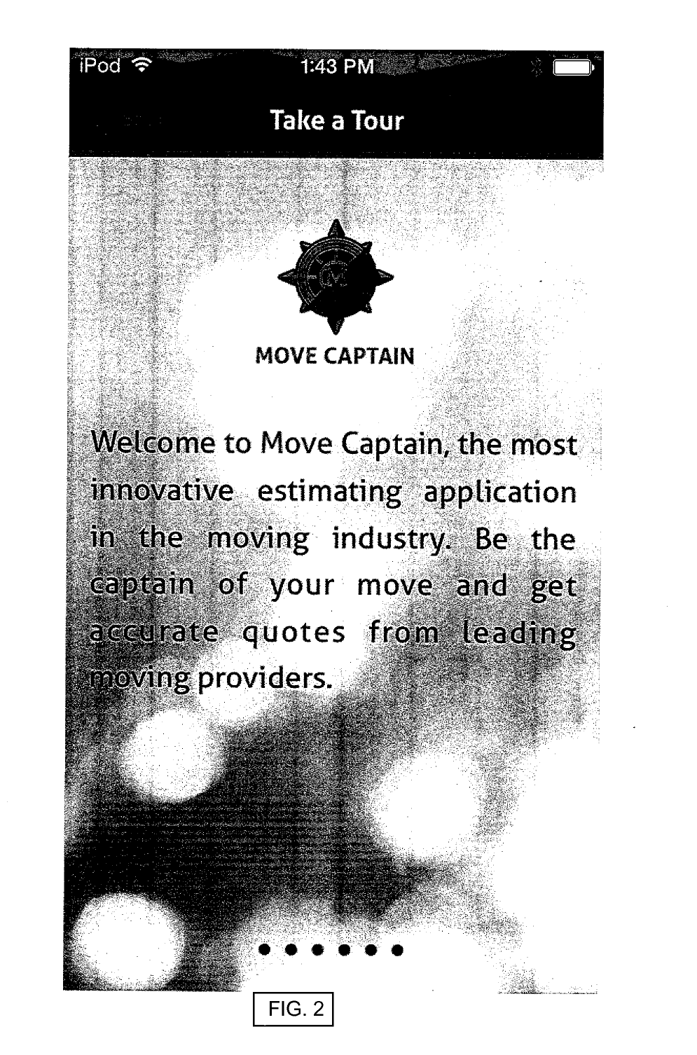

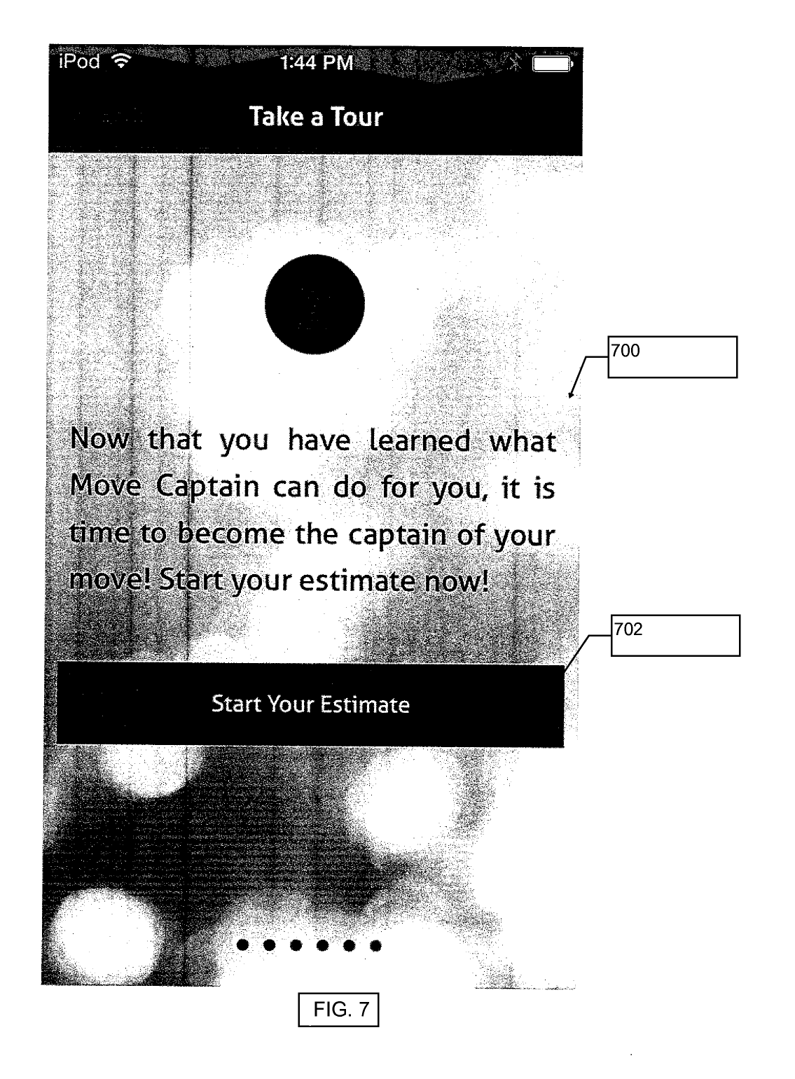

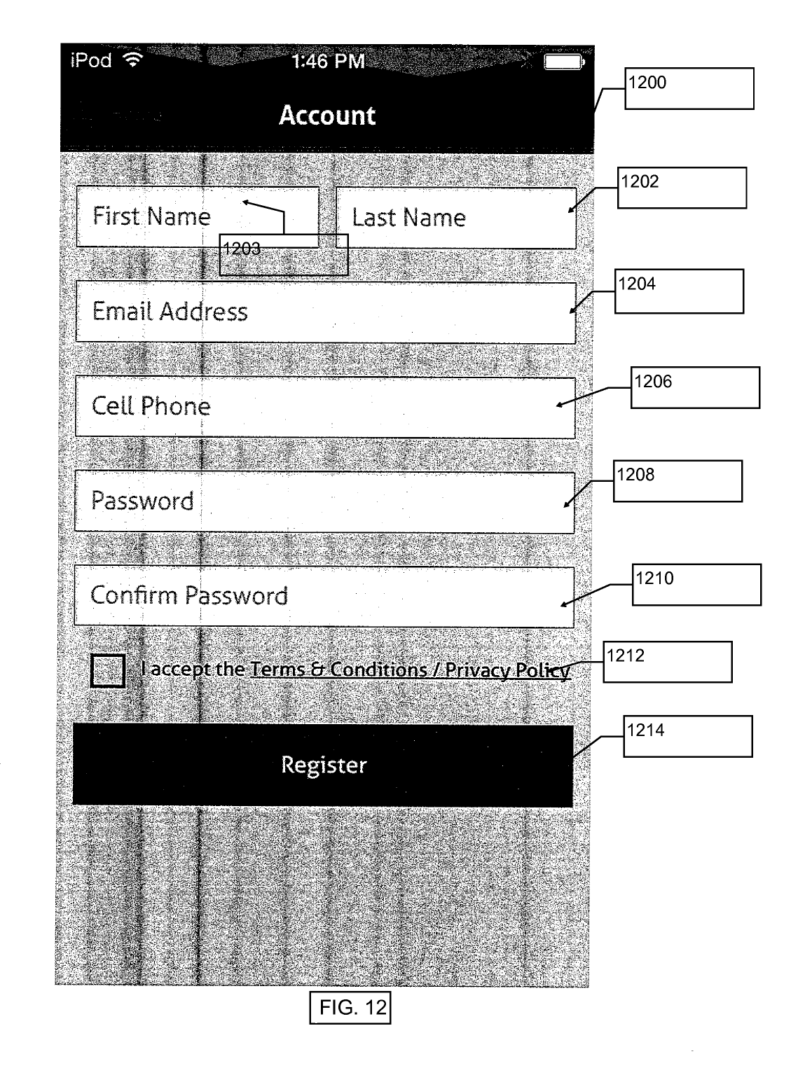

Now discussing events that may occur upon the consumer selecting take a tour option 104, on the interface 100. Several interfaces may be displayed upon the consumer selecting take a tour option 104, for example, interfaces 200-700 shown in FIGS. 2-7 may be displayed upon consumer selecting take a tour option 104 in FIG. 1. The FIGS. 2-7 illustrate various interfaces that indicate several features of the disclosed system. For example, upon the consumer selecting start your estimate option 702 on interface 700 shown in FIG. 7, interface 1200 shown in FIG. 12 may be displayed.

Now referring to FIG. 12 showing registration interface 1200. To complete the registration process and for creating a personal registration record, the consumer may need to submit the consumer's first name in an input field 1203, email address 1204, last name in an input field 1202 cellular phone number in an input field 1206 and password in an input field 1208. The consumer may have to confirm the password in input field 1210 and agree to terms and conditions by electing option 1212 before selecting a register option 1214. This registration information may be saved at a remote location over a network for subsequently validating the consumer's credentials.

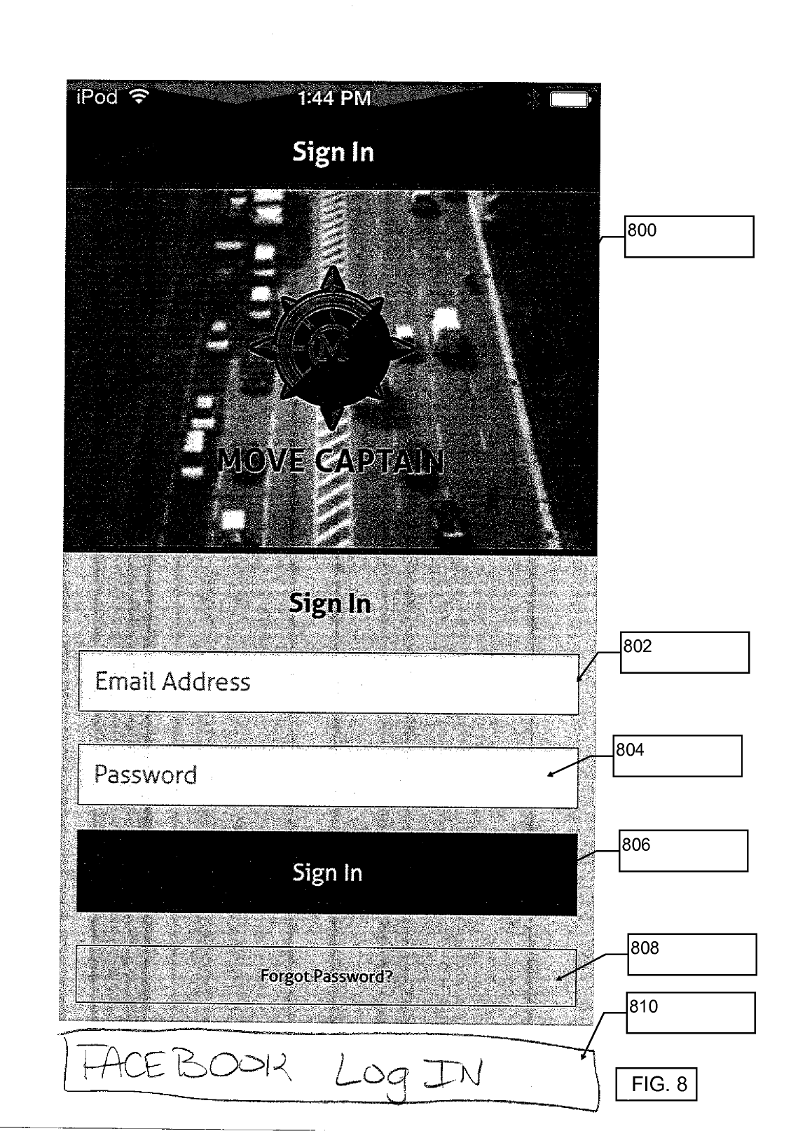

Referring back to FIG. 1, now discussing events that may occur upon the consumer selecting sign in option 106, on the interface 100. If a consumer located at a source location, who is looking to use the disclosed system for transporting items to a destination location, is a registered user of the disclosed system, then the consumer may select option 106 to log into the system. In other words, if the consumer is a registered user of the system, then the consumer may select option sign in 106 to register with the system. Upon the consumer selecting option 106, interface 800 shown in FIG. 8 may be displayed.

Now referring to FIG. 8, showing interface 800 which is an exemplary sign in interface of the disclosed system, where the previously registered consumer may log into the disclosed system. To complete the login process the consumer may need to submit the consumer's email address in an input field 802, and password in an input field 804. Then the consumer may submit this information by selecting a “Sign In” option 806. In an event a registered consumer is unable to provide the consumer's email address in an input field 802, and password in an input field 804, the consumer may select “a “forgot password” option 808 to initiate a password recovery procedure. The information provided by the consumer is then verified against the registration information for the consumer saved at a remote location. Alternatively, consumer may use social media login option 810 to sign into the disclosed system. Upon the system of disclosed invention validating the consumer's credentials via interface 800 the consumer may be able to use the disclosed system.

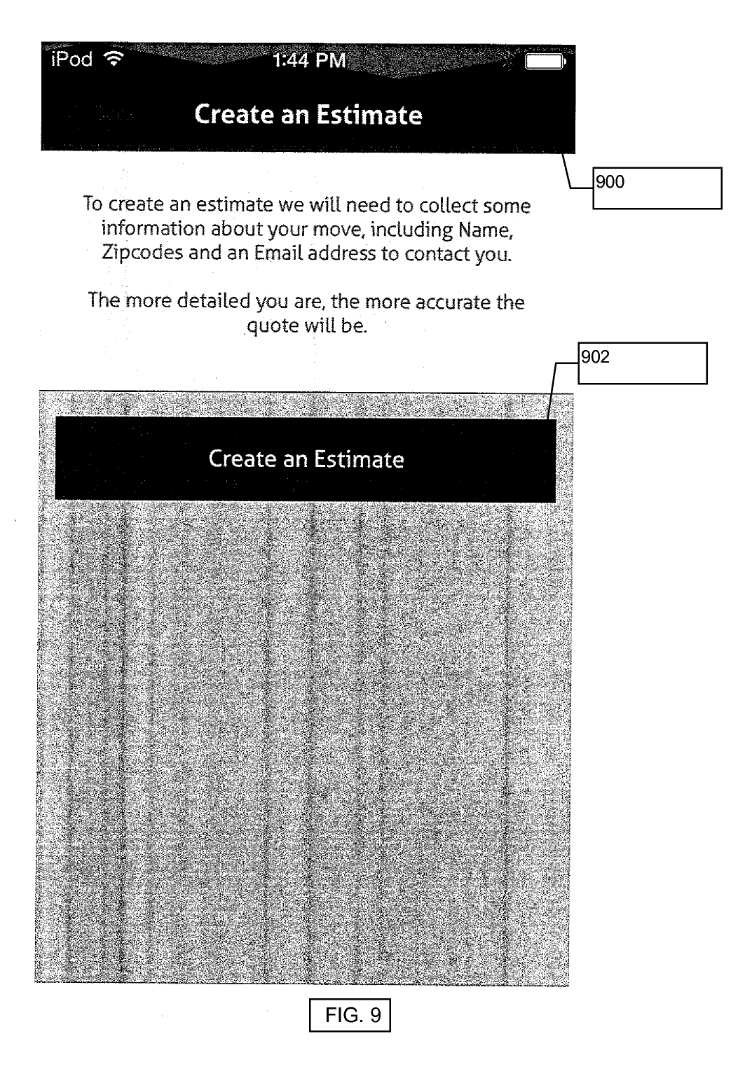

Referring back to FIG. 1, and discussing events that may occur upon the consumer selecting create an estimate option 108 on the interface 100. In an event if the consumer is not a registered user of the disclosed system, the consumer may register with the disclosed system by selecting create an estimate option 108. Interface 900 displayed in FIG. 9 may be displayed upon the consumer selecting create an estimate option 108 in FIG. 1.

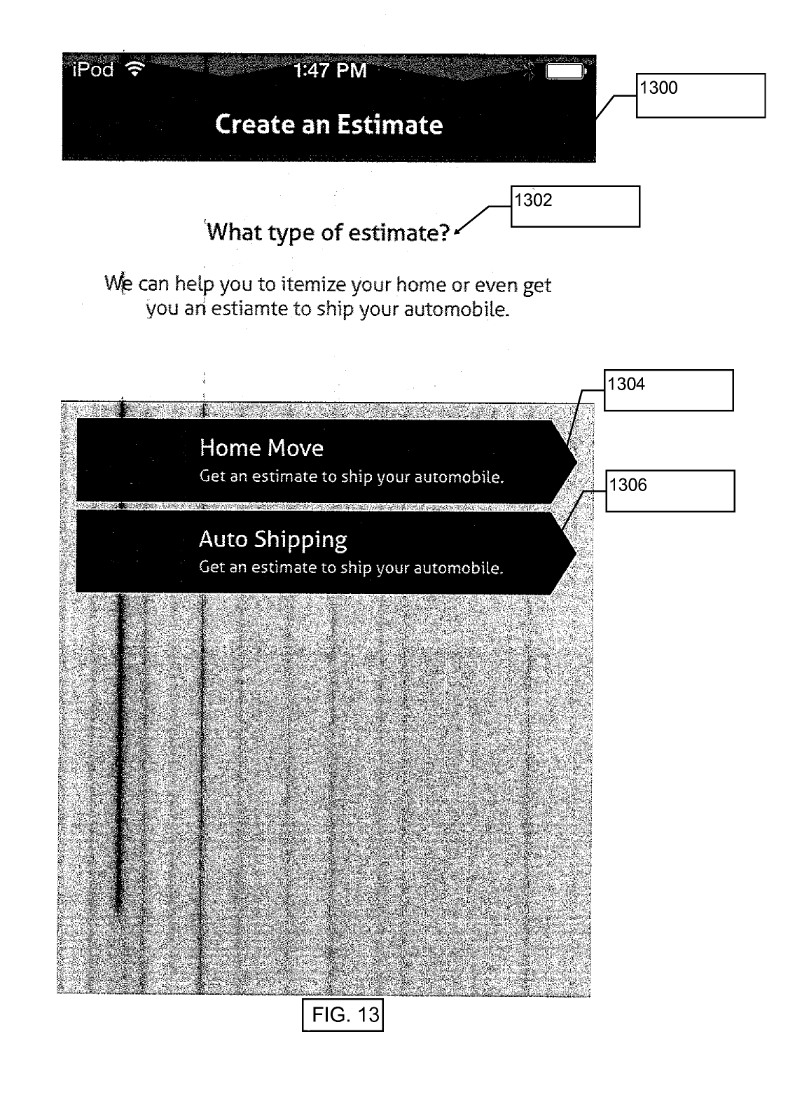

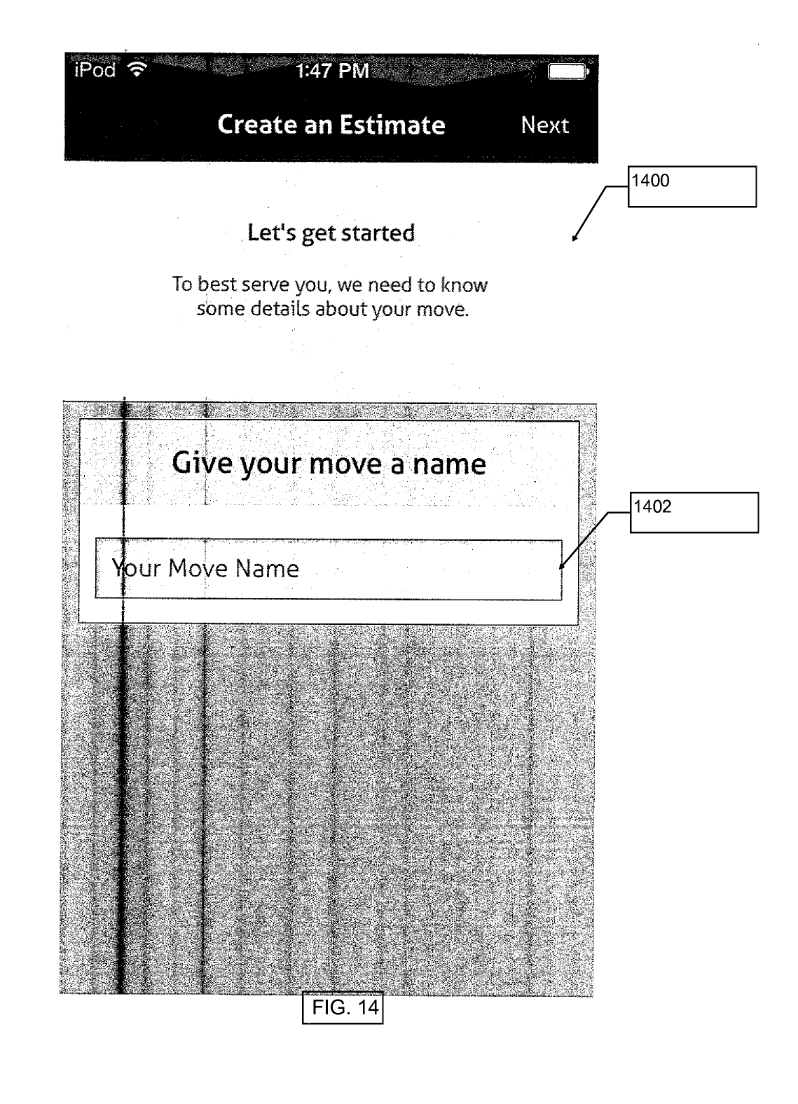

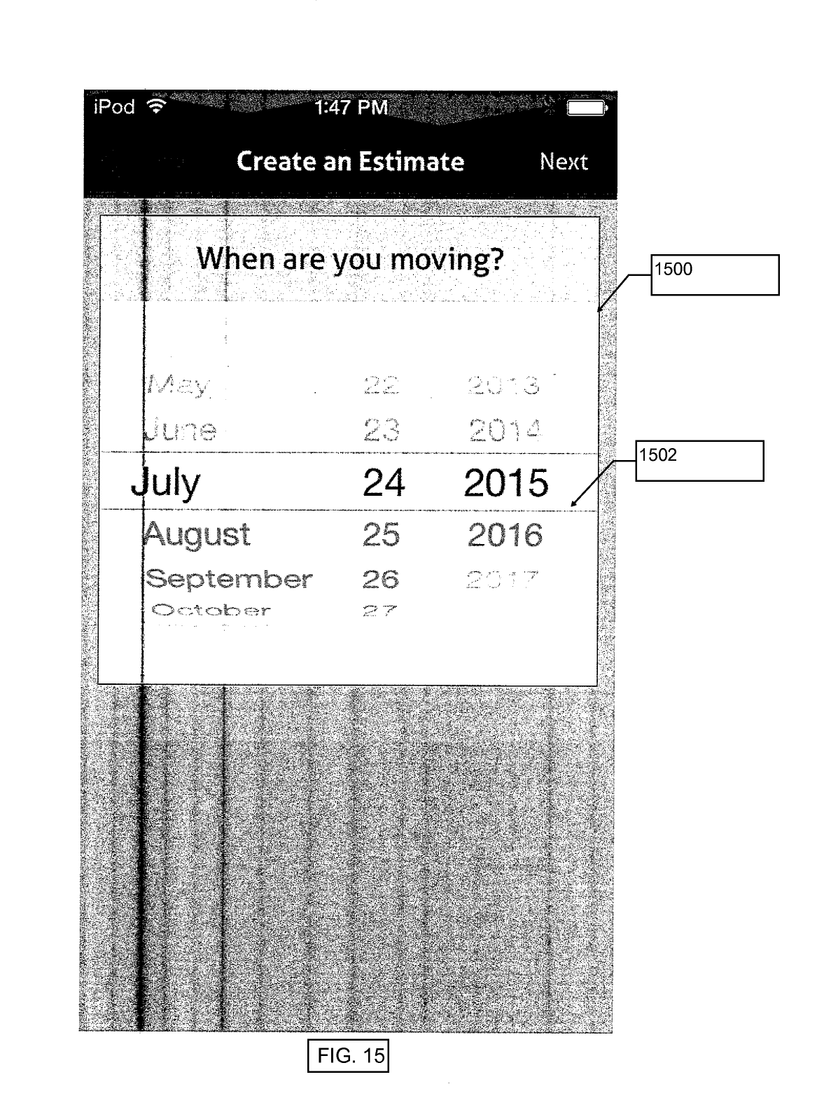

Now referring to FIG. 9 showing interface 900 wherein upon the consumer selecting create an estimate option 902, interface 1300 shown in FIG. 13 may be displayed. Now referring to FIG. 13 where in response to query 1302 prompting the consumer to select the type of estimate the consumer is seeking to generate, the consumer may select home move option 1304 or auto shipping option 1306. If the consumer selects home move option 1304, then interface 1400 shown in FIG. 14 may be displayed where the consumer may be able to input a name in the input area 1402 to assign a name to his/her upcoming move. Then interface 1500 shown in FIG. 15 may be displayed where the consumer may be able to select a move date in the date selection area 1502 to specify a move date for his/her upcoming move.

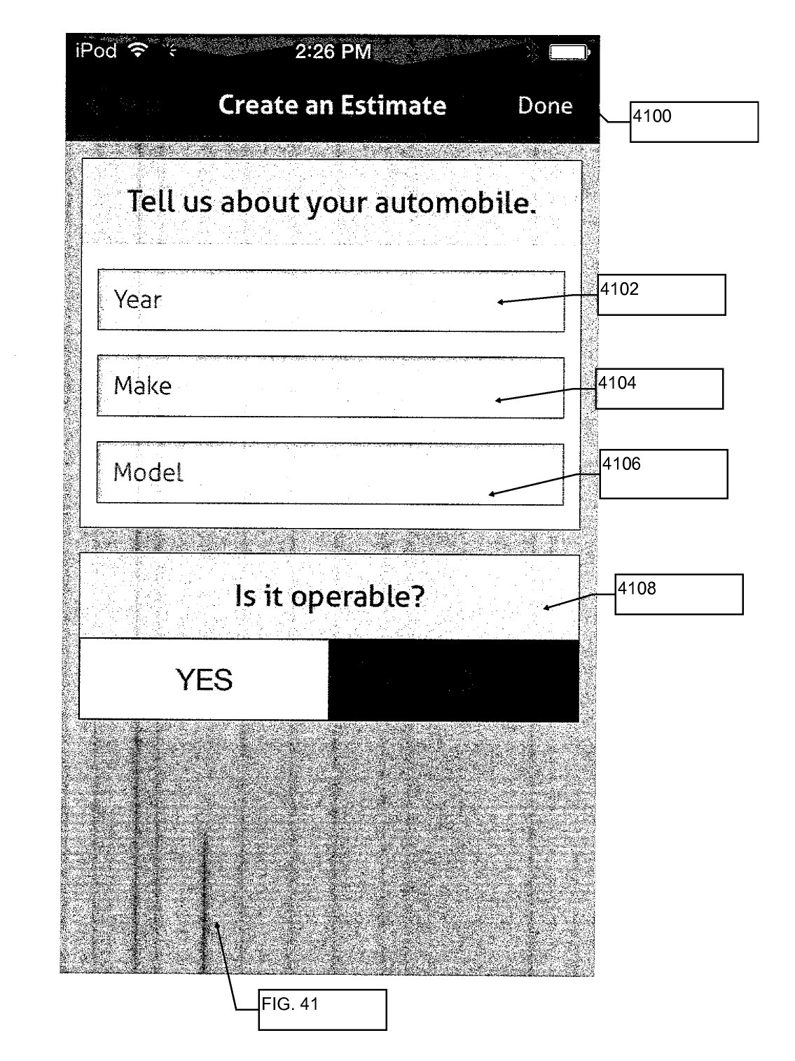

Alternatively, if the consumer selects auto shipping option 1306, then interface 4100 shown in FIG. 41 may be displayed. FIG. 41 illustrates automobile information submission interface 4100, where the consumer may be able to input automobile information such as automobile manufacturing year 4102, automobile make name 4104, automobile model name 4106, and automobile operable condition indicator 4108 may be provided via interface 4100.

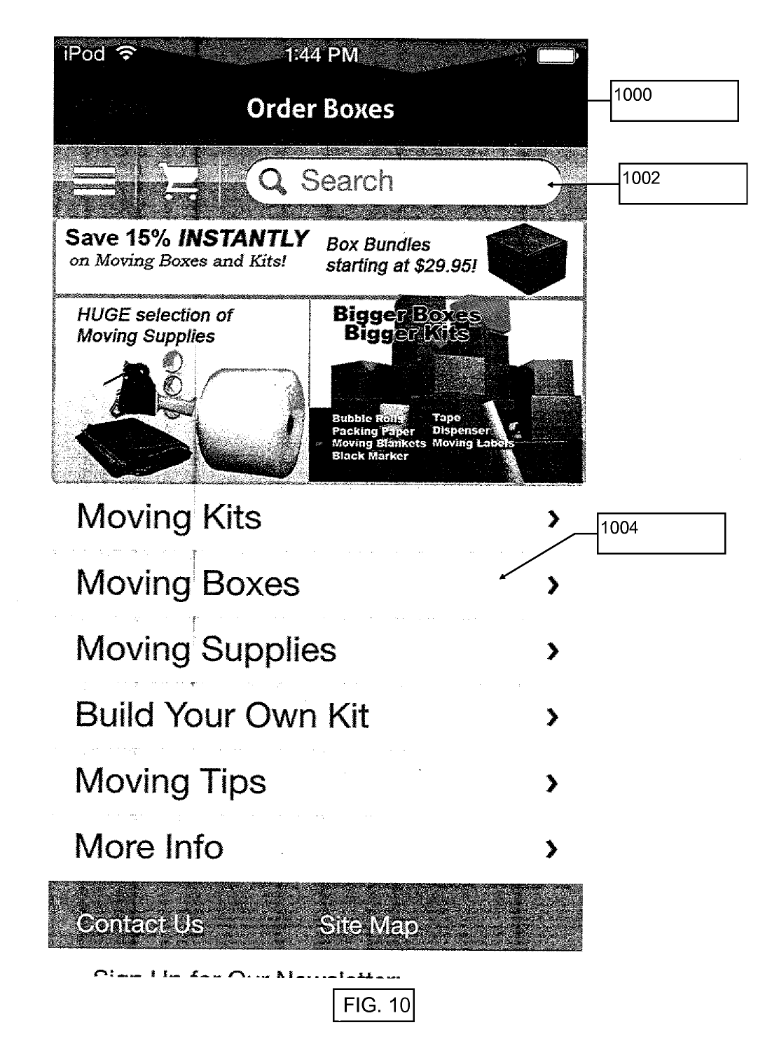

Referring back to FIG. 1, and discussing events that may occur upon the consumer selecting order boxes option 110 on the interface 100. Interface 1000 displayed in FIG. 10 may be displayed upon the consumer selecting order boxes option 110 in FIG. 1. The consumer may select boxes from options 1004 displayed on the interface 1000 or search for a desired box via search box 1002 to obtain boxes for an upcoming move.

Further, a consumer may select order boxes option 110 for whereby the system may cause the display of a box selection interface not shown in the application. The box selection interface may help the consumer in selecting a set of boxes and in selecting contents of each box. The system may also help consumer in crossing off the item which has a designated position in a box from the list of items the consumer desires to transport from the source location to the destination location.

In one embodiment of the disclosed invention, the box selection interface may be displayed after creating an inventory of items that are to be transmitted from the source location to the destination location. In that embodiment, the consumer is given a proposal of contents of each box and a proposal of layout of the contents in each box. For example, bubble wrap insulated boxes may be used to pack pillows on all four sides and an antique vase in the middle. Once the contents and layout of the contents are defined for each box, then the task of packing the contents may be more streamlined because the packing personnel may have a complete listing of boxes, contents of each box and layout of each box.

Alternatively, in another embodiment the consumer may select the number of boxes, manually configure both the contents and the layout of each box. In yet another embodiment, the consumer may simply select a number of boxes and not define either contents or layout of the boxes. In each of the aforementioned embodiments, the consumer may use the convenient feature of the disclosed system to have the boxes delivered to the consumer's door steps.

In other words, the system may help the consumer to precisely identify which items are to be moved from the source location to the destination location. The system may be able to first identify the items that are to be moved from the source location to the destination location, conduct weight-volume-distance analysis to generate a moving cost estimation. Furthermore, a consumer may select home services option for connecting various services to the destination location. For example, by selecting the home services option the consumer may be able to connect cable service, phone service or internet service at the destination location. Optionally other services can also be selected including but not limited to connecting electricity, natural gas, cleaning service, and the like. These features may reduce stress and chaos associated with a typical transition from a source location to a destination location.

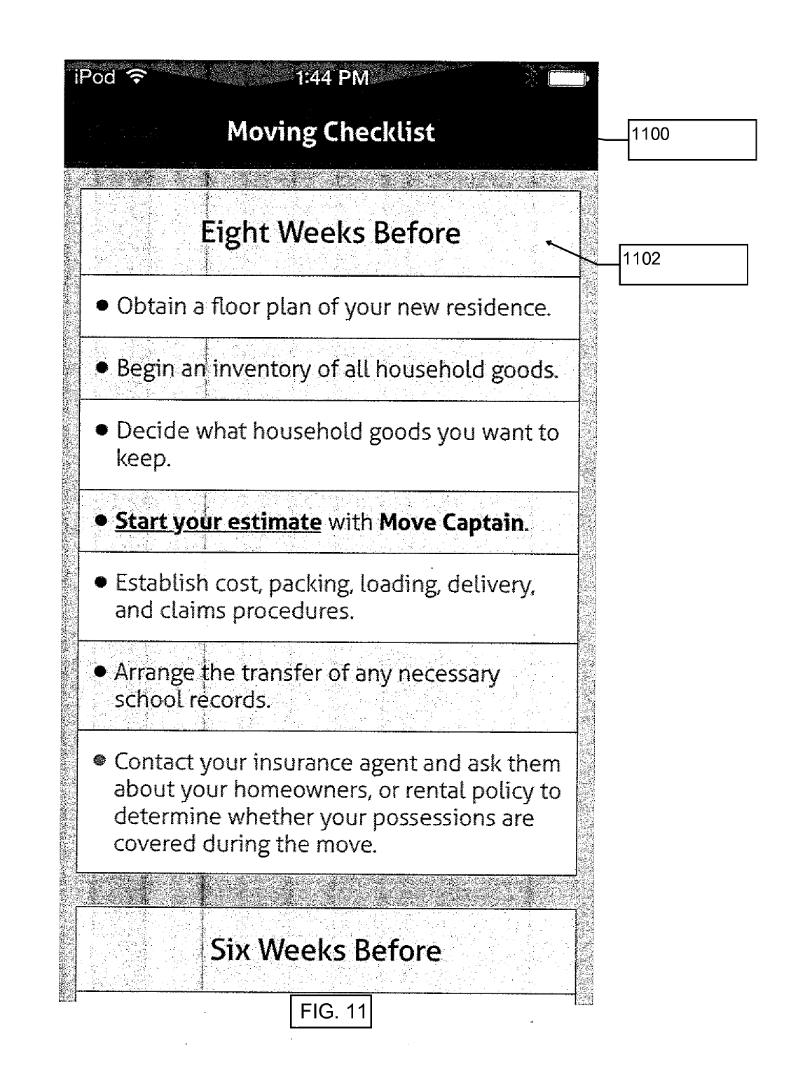

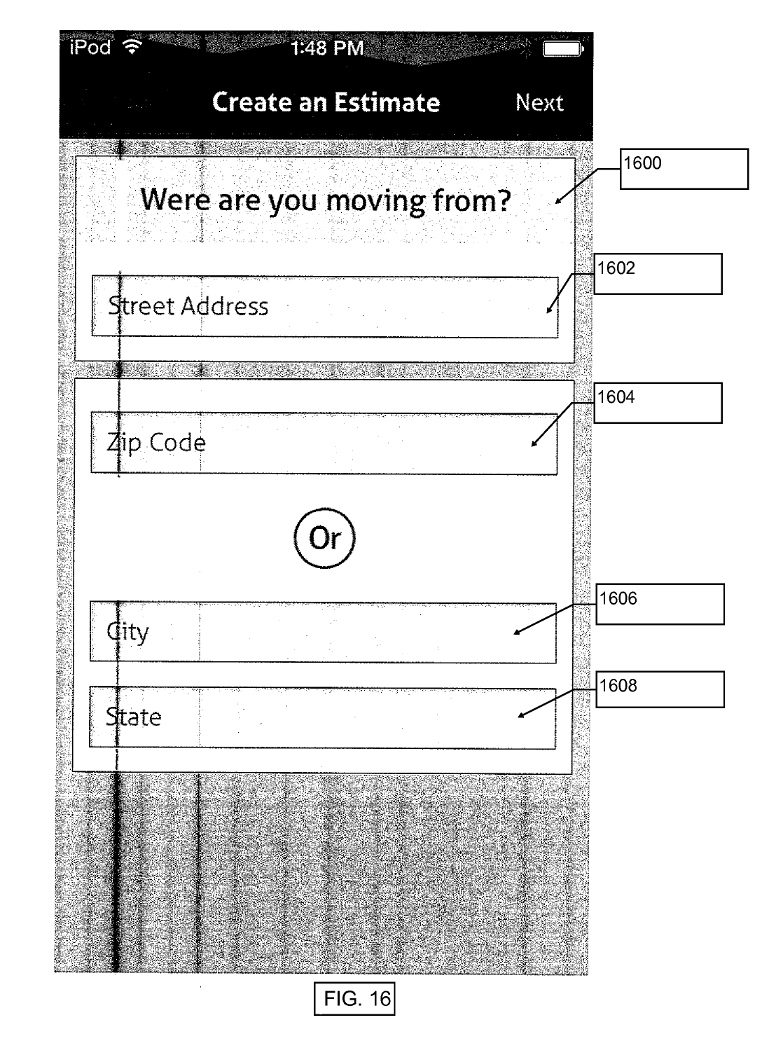

Referring back to FIG. 1, and discussing events that may occur upon the consumer selecting moving checklist option 112 on the interface 100. Interface 1100 displayed in FIG. 11 may be displayed upon the consumer selecting moving checklist option 112 in FIG. 1. The consumer may view a checklist 1002 displayed on the interface 1100 enumerating steps the consumer should follow leading up to move day. Furthermore, the consumer may specify source location information via interface 1600 shown in FIG. 16 where the consumer may provide source location street address in the input area 1602, source location zip code in the input area 1604, or optionally provide source location city in the input area 1606 and source location state in the input area 1608.

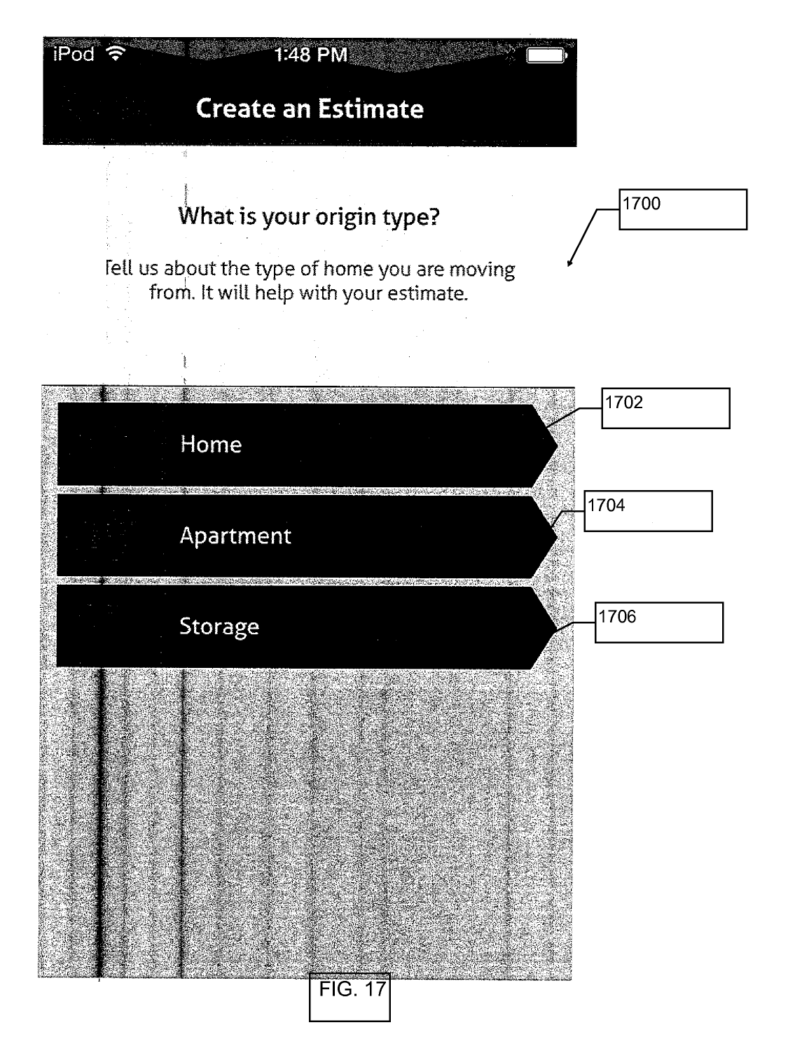

Now turning to FIG. 17 where in response to query “what is your origin type” on interface 1700, the consumer may indicate source location type information by selecting whether the source location is a house, an apartment or a storage facility by selecting selection fields 1702, 1704, or 1706 respectively.

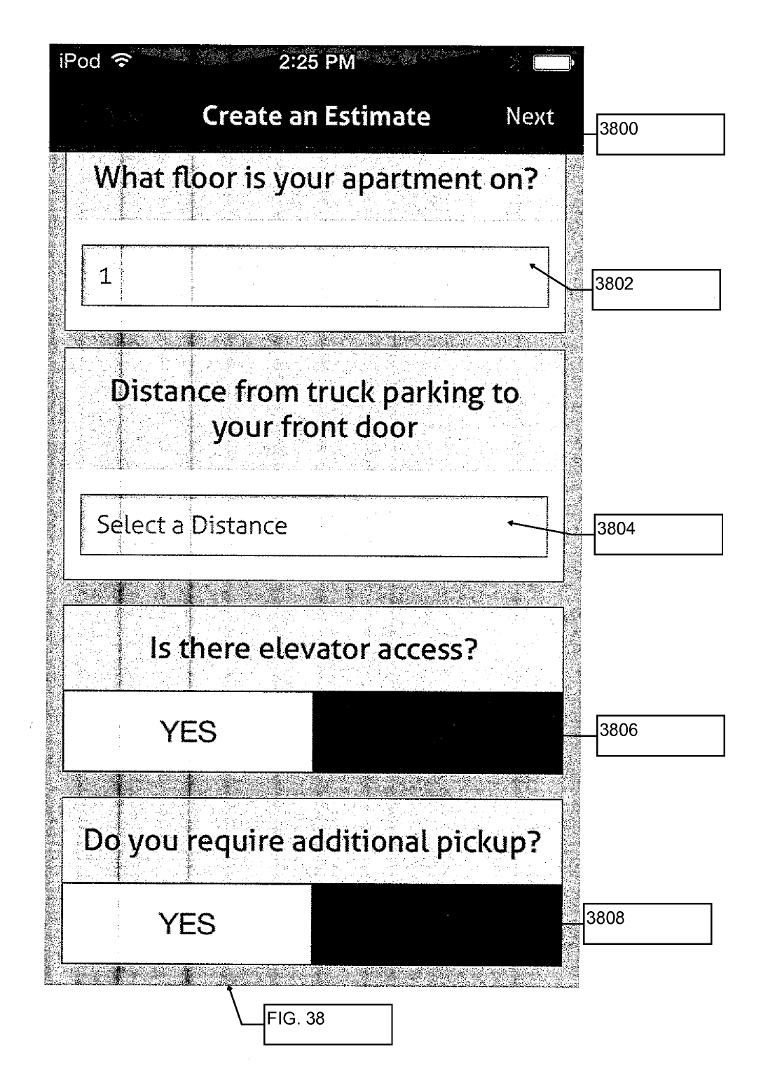

If the selected origin type on the interface 1700 is an apartment then interface 3800 shown in FIG. 38 may be displayed. FIG. 38 illustrates the source location apartment information submission interface 3800 of the disclosed invention, where a query asking what floor the apartment is located on is presented to the consumer. To answer the query, consumer may select the floor number 3802 for the apartment and indicate distance from truck parking to consumer's front door in the input field 3804. Additionally, the consumer may also indicate whether or not the apartment has an elevator access at field 3806 before specifying whether or not the consumer needs additional pickup by selecting yes or no option 3808.

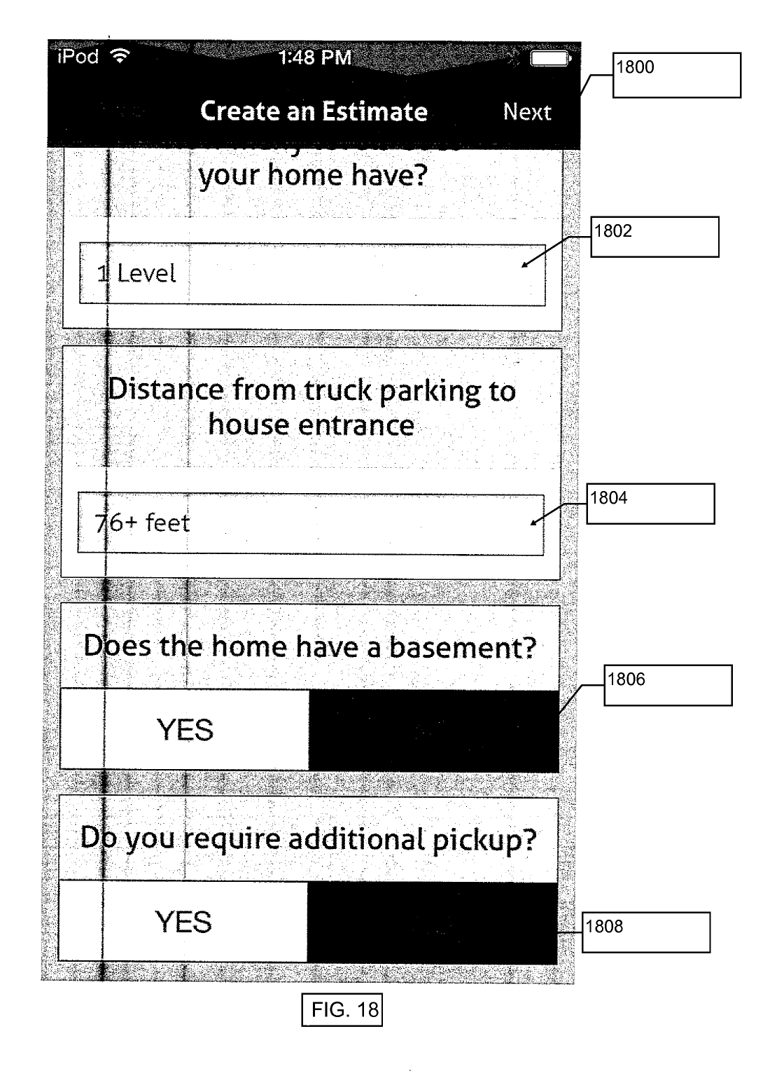

Alternatively, if the selected origin type on the interface 1700 is a house then interface 1800 shown in FIG. 18 may be displayed. FIG. 18 illustrates depicts the home information submission interface 1800 of the disclosed invention. Via interface 1800, the consumer may select the number of levels in the input area 1802 for the house such as level one, two or three and indicate the distance in feet from truck parking to house entrance in the input area 1804. The consumer may also indicate whether the source residence has a basement in the input area 1806 before specifying whether the consumer needs additional pickup in the input area 1808.

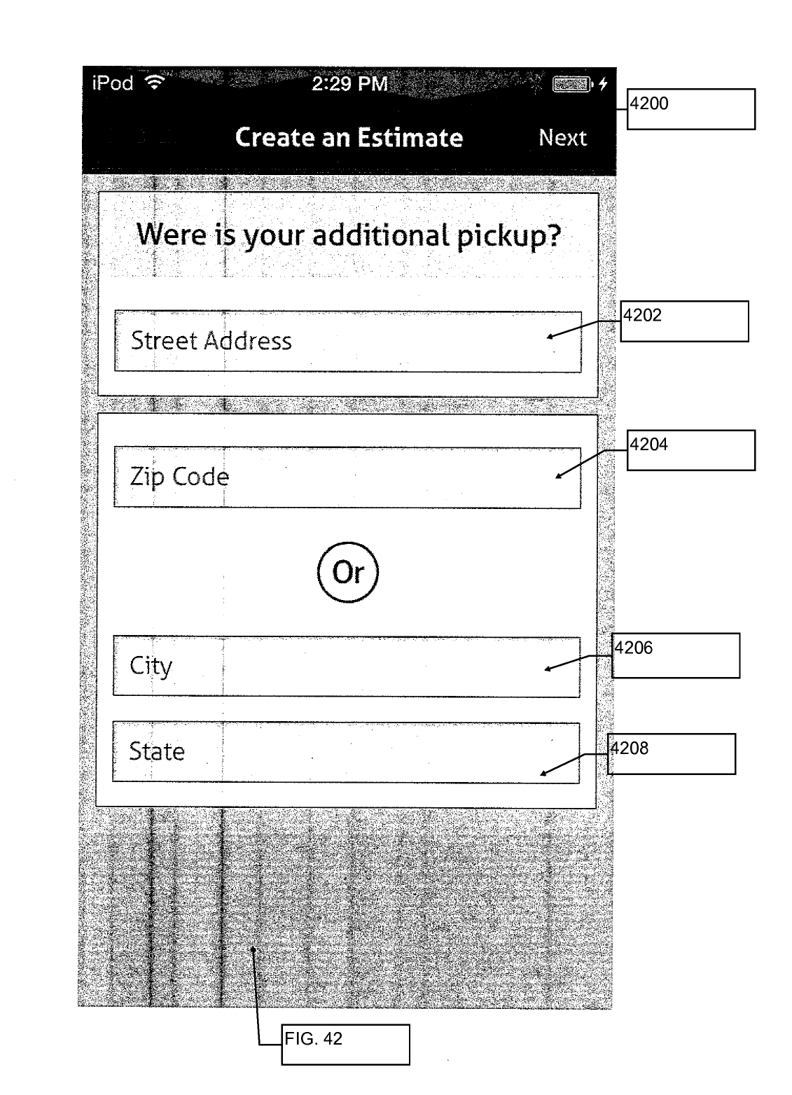

If the consumer selects option yes indicating that the consumer needs additional pick up then interface 4200 shown in FIG. 42 may be displayed. FIG. 42 illustrates additional pickup information submission interface 4200, where the consumer may specify location information where additional pickup is needed via interface 4200 shown in FIG. 42 where the consumer may provide origin location street address in the input area 4202, origin location zip code in the input area 4204, or optionally provide origin location city in the input area 4206 and origin location state in the input area 4208.

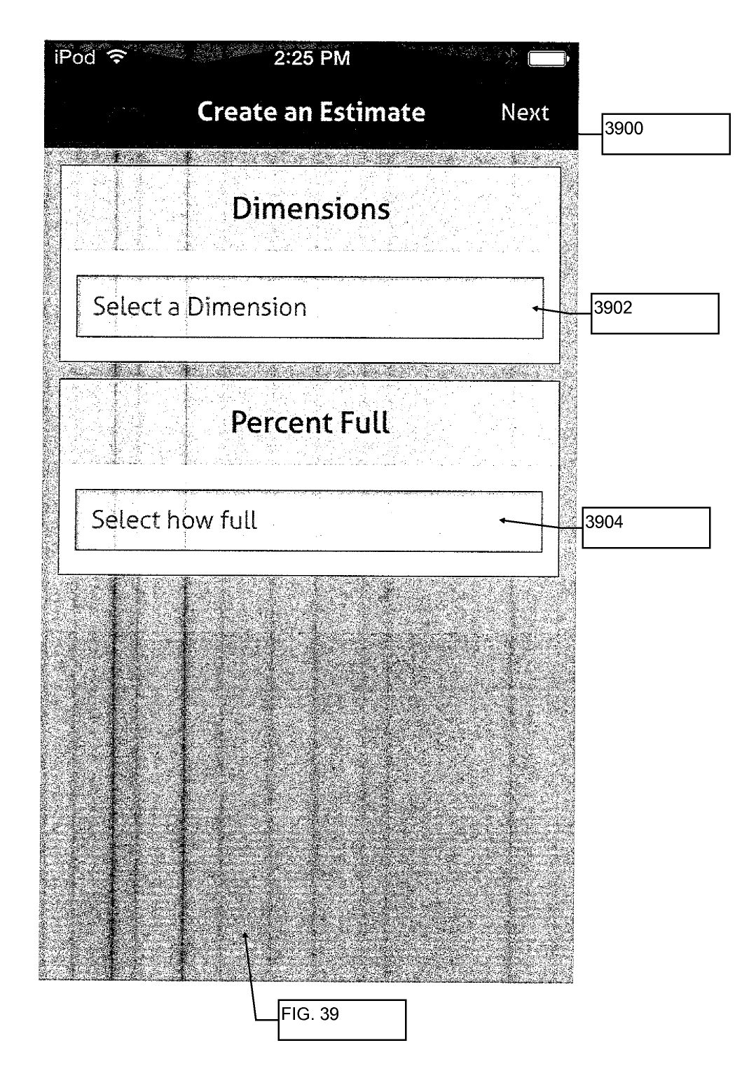

On the other hand, if the selected origin type on the interface 1700 is a storage facility, then interface 3900 shown in FIG. 39 may be displayed. FIG. 39 illustrates the source location storage facility information submission interface 3900 of the disclosed invention, where consumer may select the dimensions of the storage facility in the input area 3902 and indicate the filled volume percentage of the storage facility in the input area 3904. This may help in estimating the contents of the storage facility for generating move estimation.

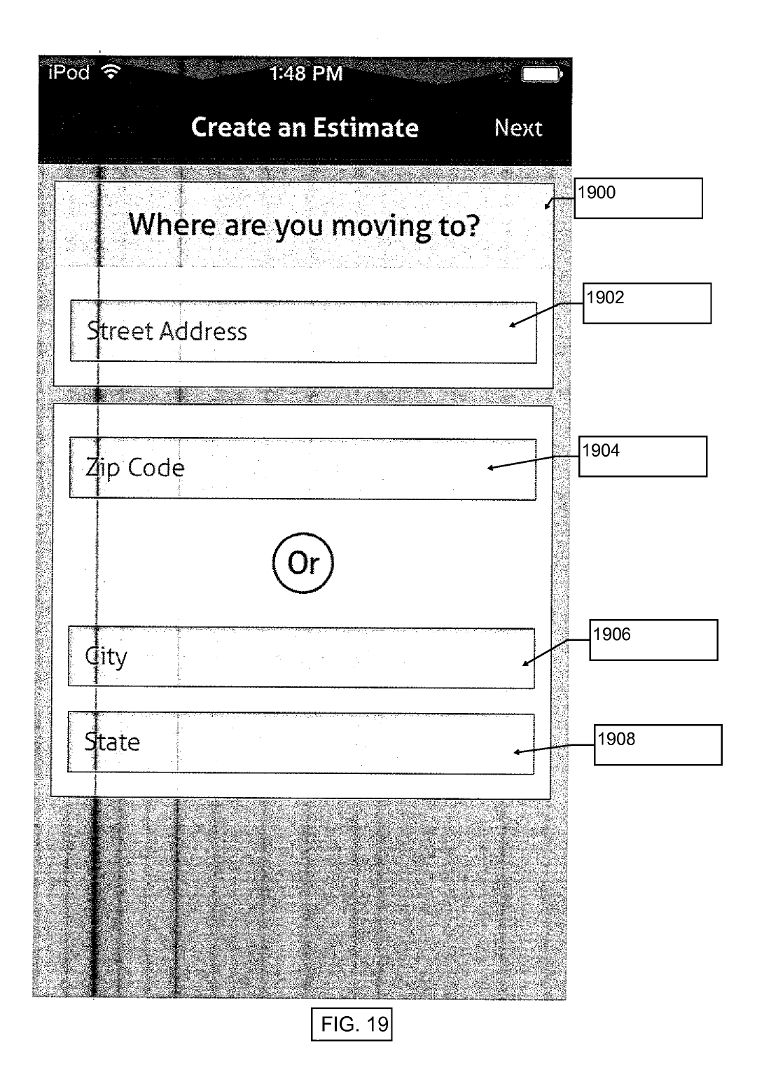

In FIG. 19, the consumer may specify destination location information via interface 1900 shown in FIG. 19 where the consumer may provide destination location street address in the input area 1902, destination location zip code in the input area 1904, or optionally provide destination location city in the input area 1906 and destination location state in the input area 1908.

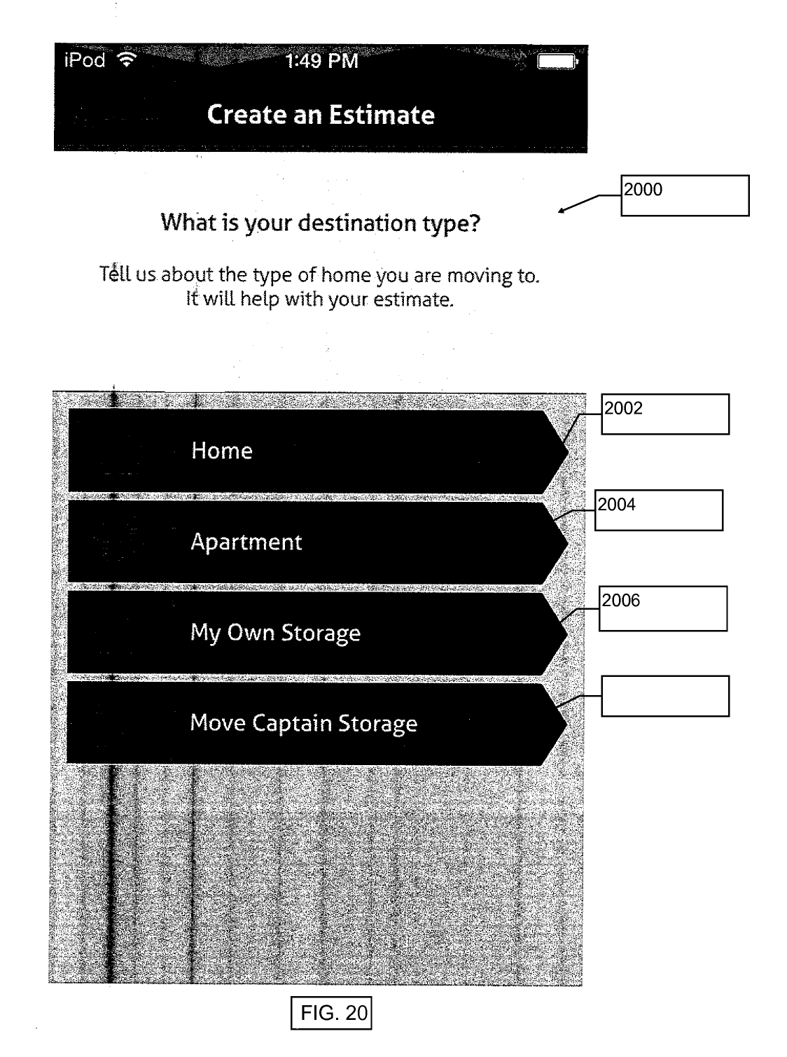

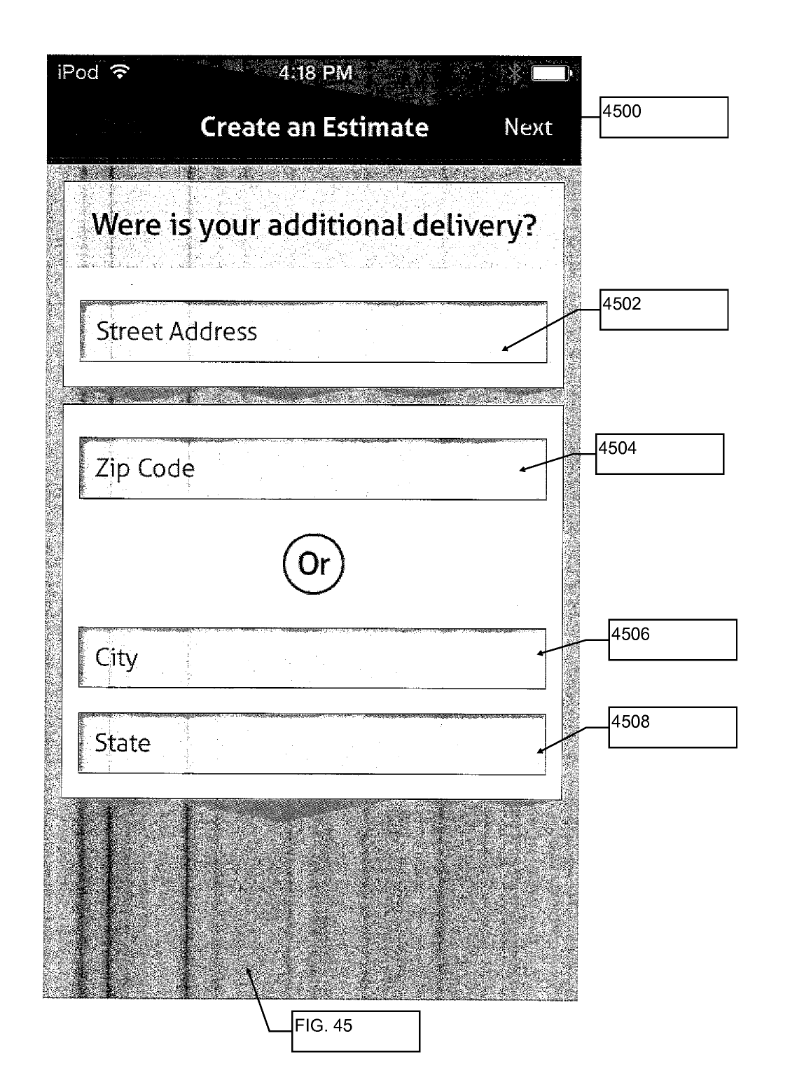

Now turning to FIG. 20 showing destination location type submission interface 2000 of the disclosed invention. In response to query “what is your origin type” on interface 2000, the consumer may indicate destination location type information by selecting whether the destination location is a house, an apartment, consumer's privately rented a storage facility, or Move Captain storage facility by selecting selection fields 2002, 2004, 2006 or 2008 respectively. If the selected destination type is a house then interface 2100 may be displayed where consumer may select the number of levels in the input area 2102 for the house such as level one, two or three and indicate the distance in feet from truck parking to house entrance in the input area 2104. The consumer may also indicate whether the destination residence has a basement in the input area 2106 before specifying whether the consumer needs additional delivery in the input area 2108. If the consumer selects to have additional delivery, then interface 4500 shown in FIG. 45 may be displayed.

FIG. 45 illustrates additional delivery information submission interface 4500 of the disclosed invention the consumer may provide destination location information where additional delivery is to be dispatched via interface 4500. For example, the consumer may provide destination location street address in the input area 4502, destination location zip code in the input area 4504, or optionally provide destination location city in the input area 4506 and destination location state in the input area 4508.

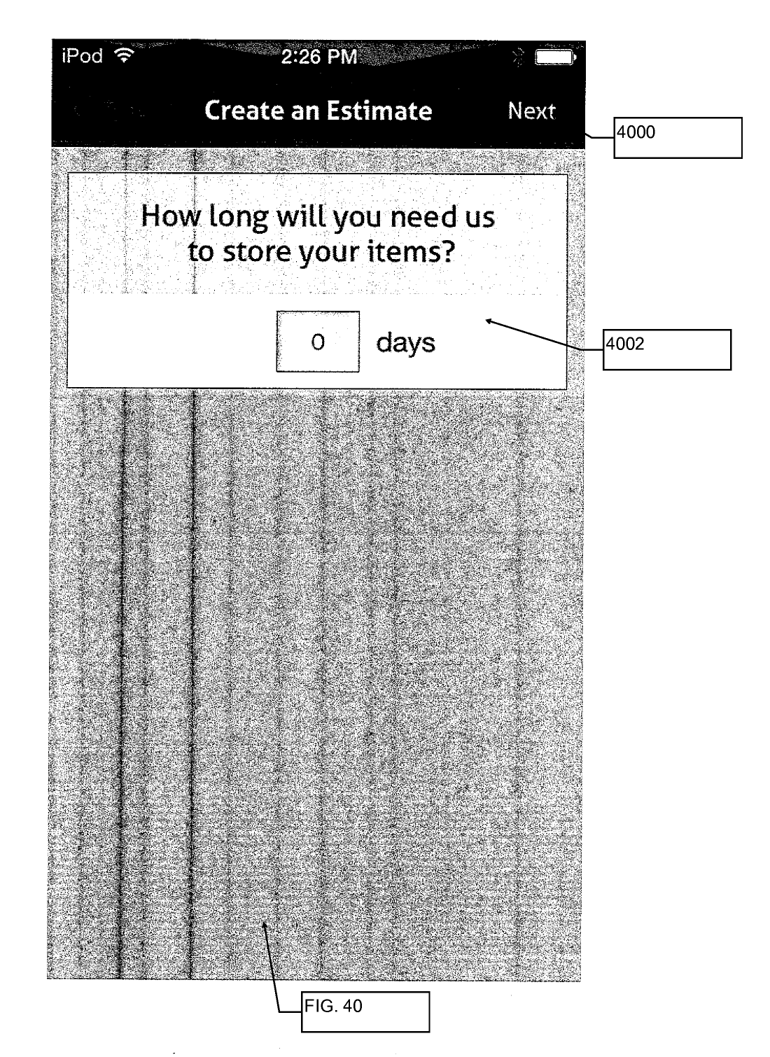

Turning back to FIG. 20, alternatively, if the selected destination type is Move Captain Storage 2008, then interface 4000 shown in FIG. 40 may be displayed. FIG. 40 depicts storage requirement submission interface 4000, where consumer may specify the number of days in the input area 4002 the consumer wants to store his/her belongings with Move Captain storage facility.

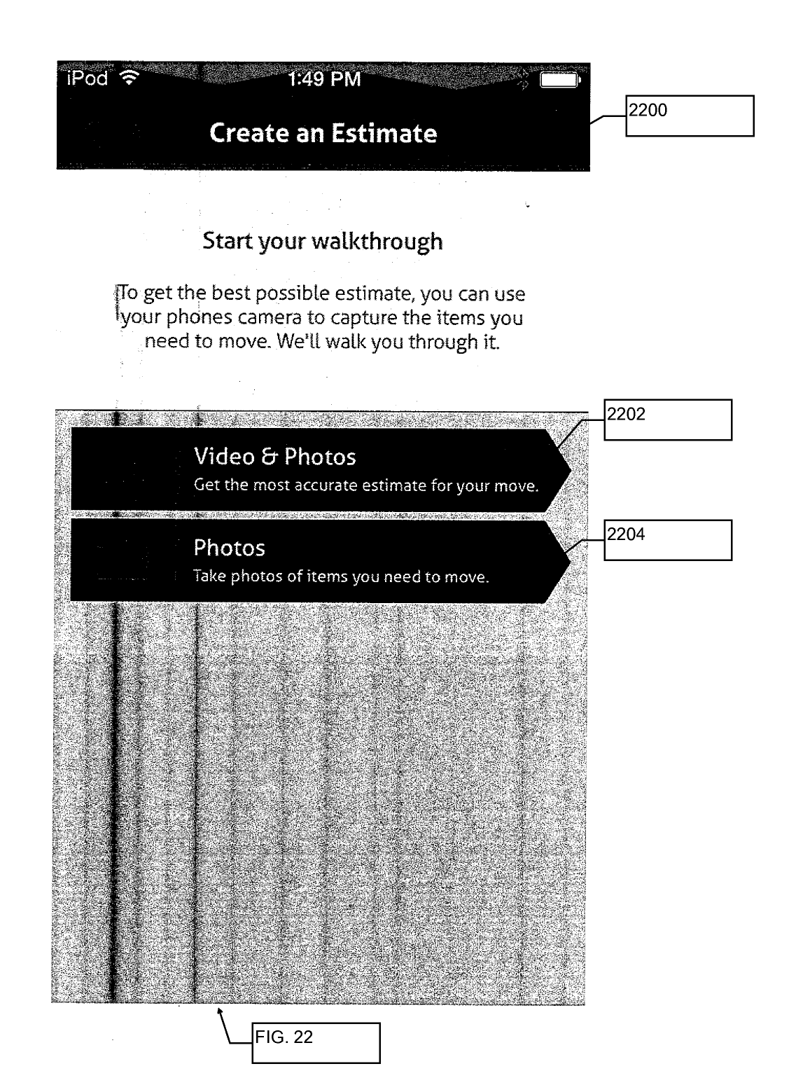

The consumer may start his/her walkthrough via interface 2200 shown in FIG. 22. The consumer may select videos and photos option 2202 to identify the items to be moved from the source location to the destination location via both photographs and videos. Alternatively, the consumer may select photos option 2204 to identify the items to be moved from the source location to the destination location only via photographs. The photographs and video may help in generating a realistic estimate for the move.

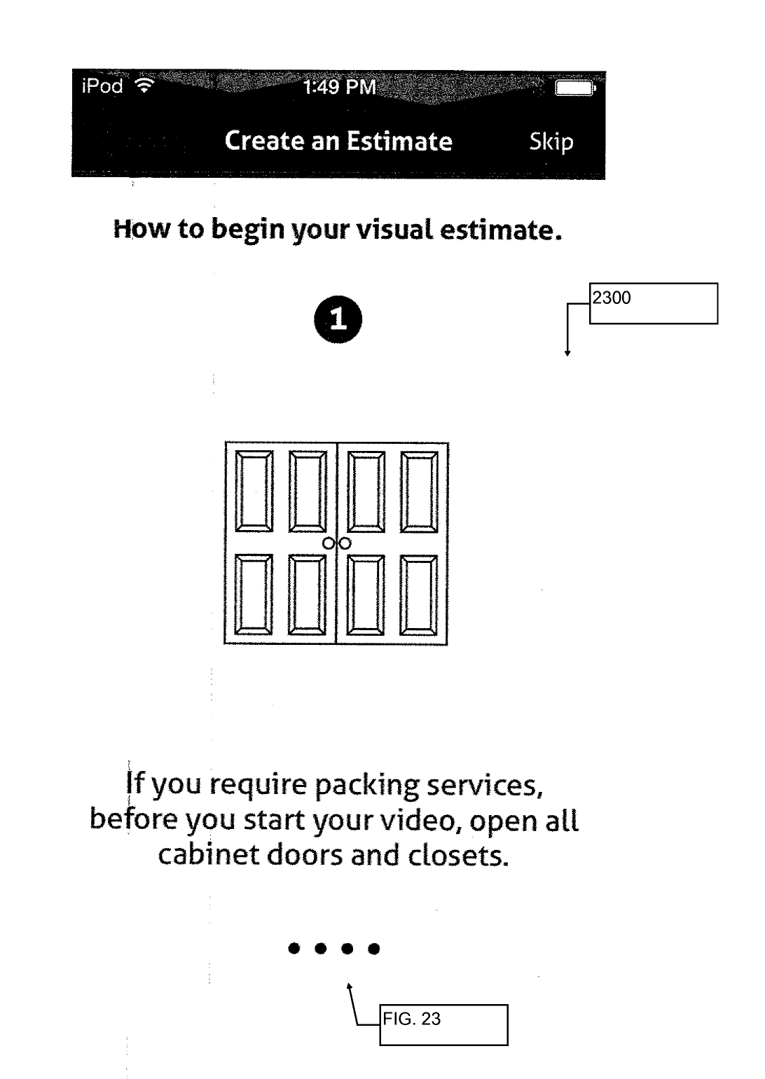

FIGS. 23-26 illustrate various instructions for showing consumers various pointers for capturing images and video recording of the items to be moved from the source location to the destination location.

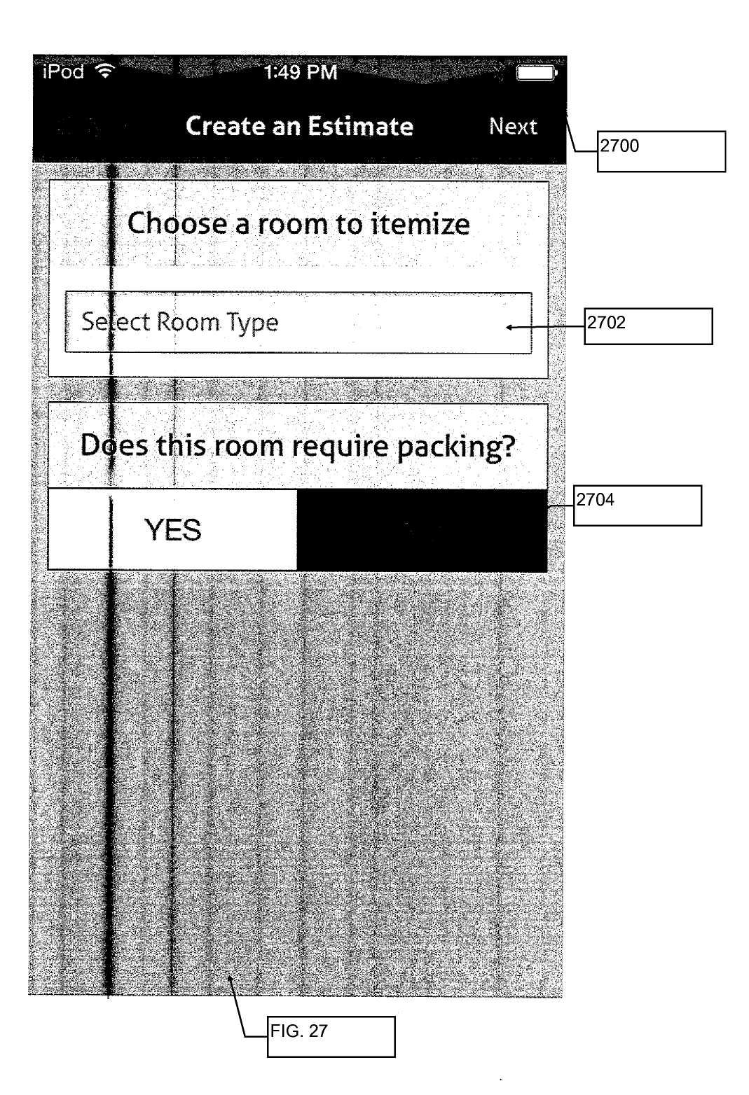

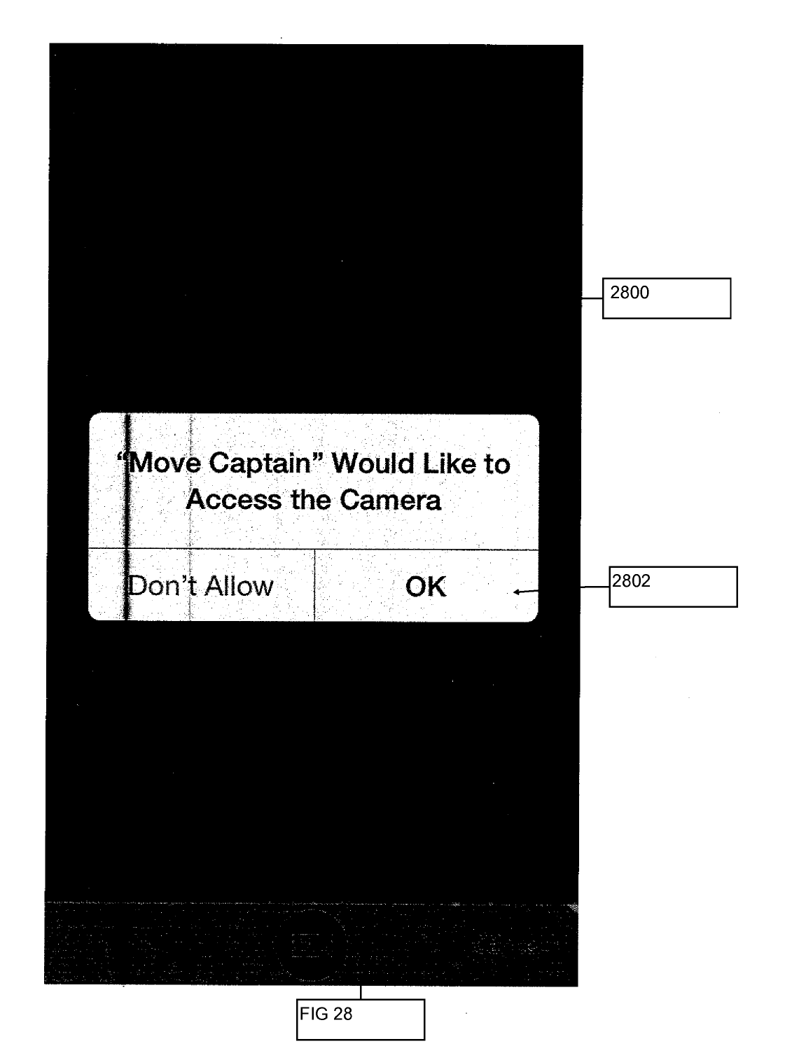

Turning now to FIG. 27 showing room type selection interface 2700 showing a list of rooms 2702. Consumer may select a room from the list of rooms which the consumer desires to record and specify whether the selected requires packing by selecting yes or no option 2704. The system may via interface 2800 shown in FIG. 28 present a camera access request to the consumer whereby the system may present a pop up notification asking for access the contents of the consumer's camera. In response, the consumer may accept or reject the access request by selecting ok or don't allow option 2802. Using camera function of the consumer's device the consumer may be able to take pictures or video capture of the items that are to be moved to the destination location.

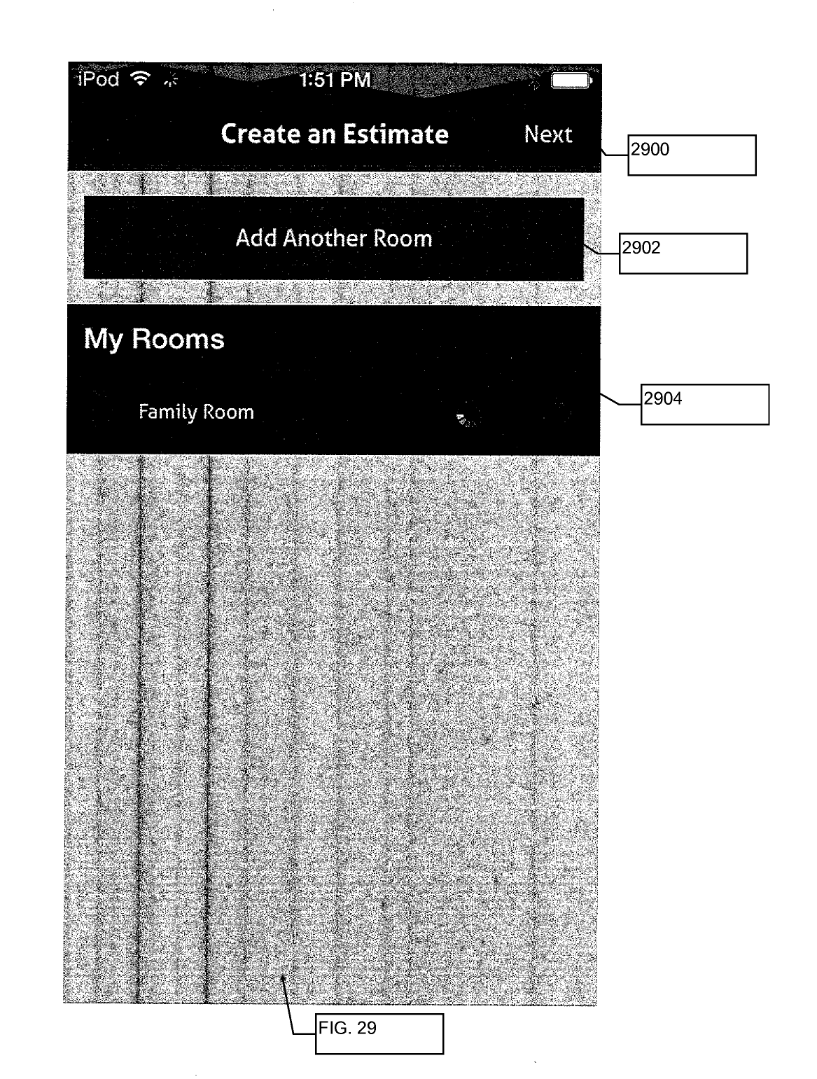

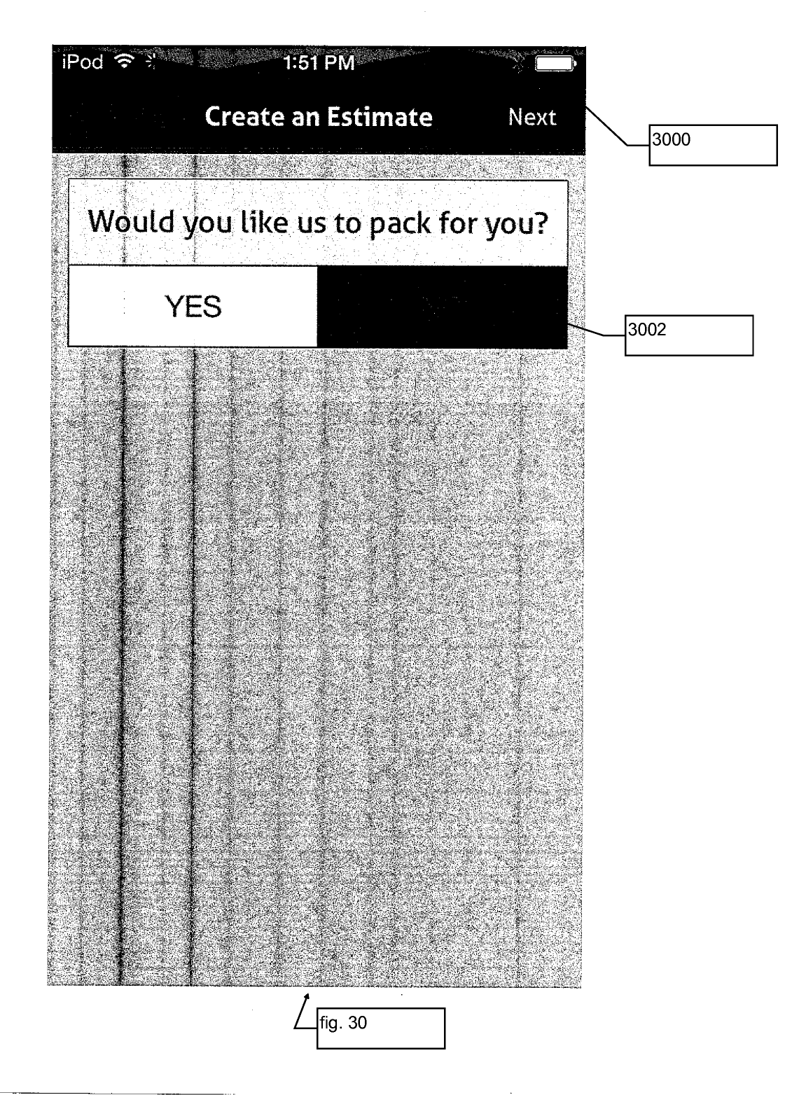

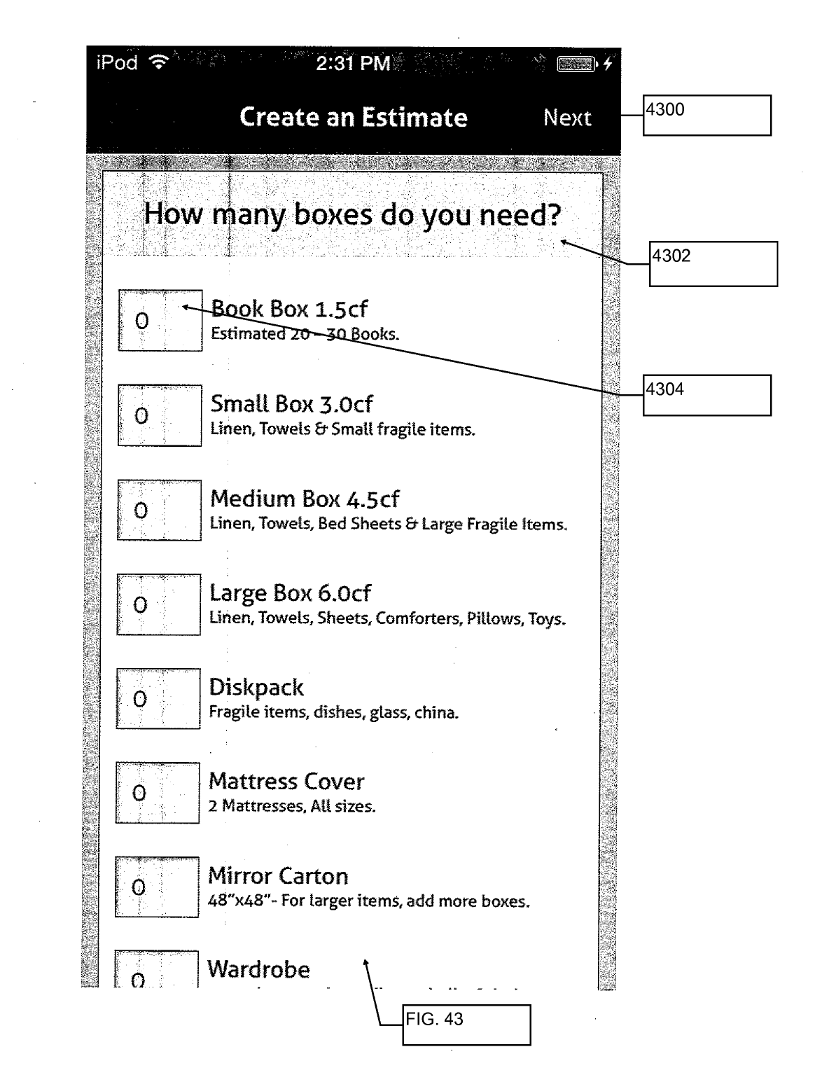

Interface 2900 shown in FIG. 29 may present the consumer an option to add another room 2902. If this option is selected then interface 2700 may be displayed and after the system completes processing add another room request, the added room may be displayed in my rooms display area 2904. FIG. 30 shows a packing outsourcing option selection interface 3000 of the disclosed system. The consumer may be prompted via interface 3000 shown in FIG. 30 whether or not the consumer would like to have his/her items packed. In response, the consumer may select yes or no option 3002. If the consumer selects yes option, then interface 4300 shown in FIG. 43 may be displayed. FIG. 43 depicts packing material request interface 4300, which may present a query 4302 asking consumer how many boxes does the consumer need. The consumer may indicate number of required boxes at the input field 4304.

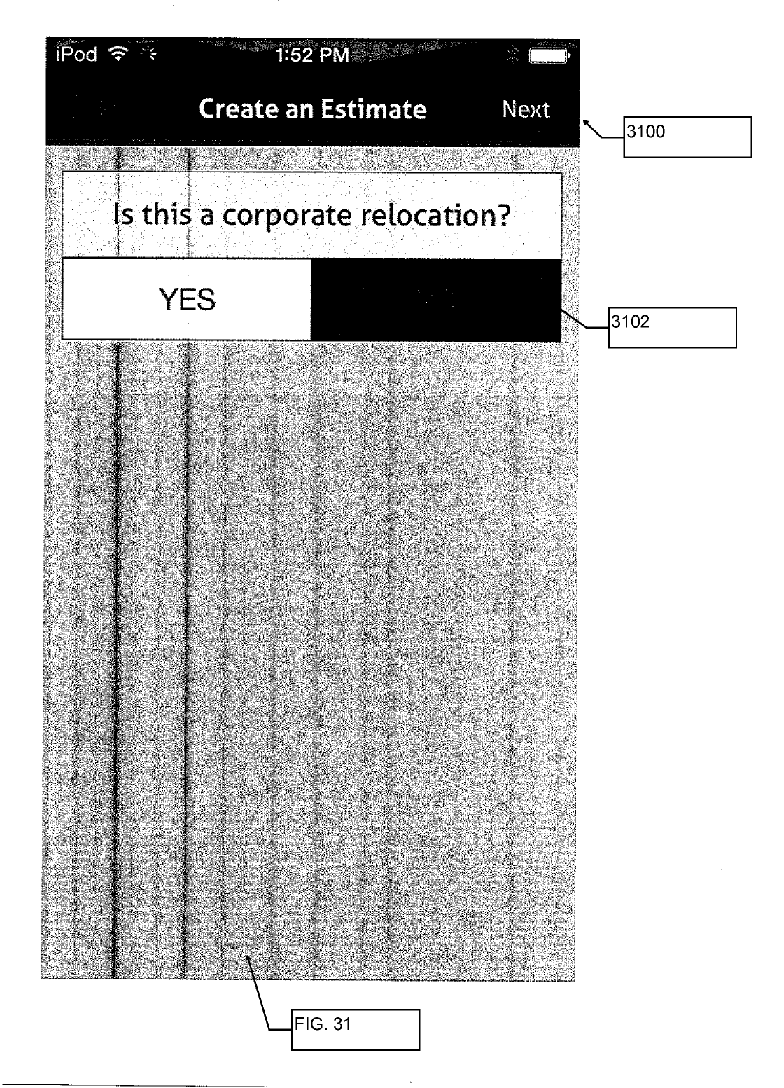

FIG. 31 depicts a corporate relocation request submission interface 3100 which may present a query for the consumer stating whether the move for which an estimation is sought is a corporate move. The consumer may select a choice yes or no in the input field 3102. In one embodiment of the disclosed invention, the consumer may configure the consumer account profile information such as consumer's first name, last name, cellular phone number, email address, password, and the like. By selecting a sign out option, not shown in FIG. 1-44, the consumer may sign out of the system. This feature of the disclosed system may be helpful for example when a consumer who is business owner seeking to relocate the consumer's business and residence to a destination location. In this situation, the aforementioned functions can be performed by the consumer by logging into two separate accounts, one account may be used for the business relocation and another account may be used for the residence relocation.

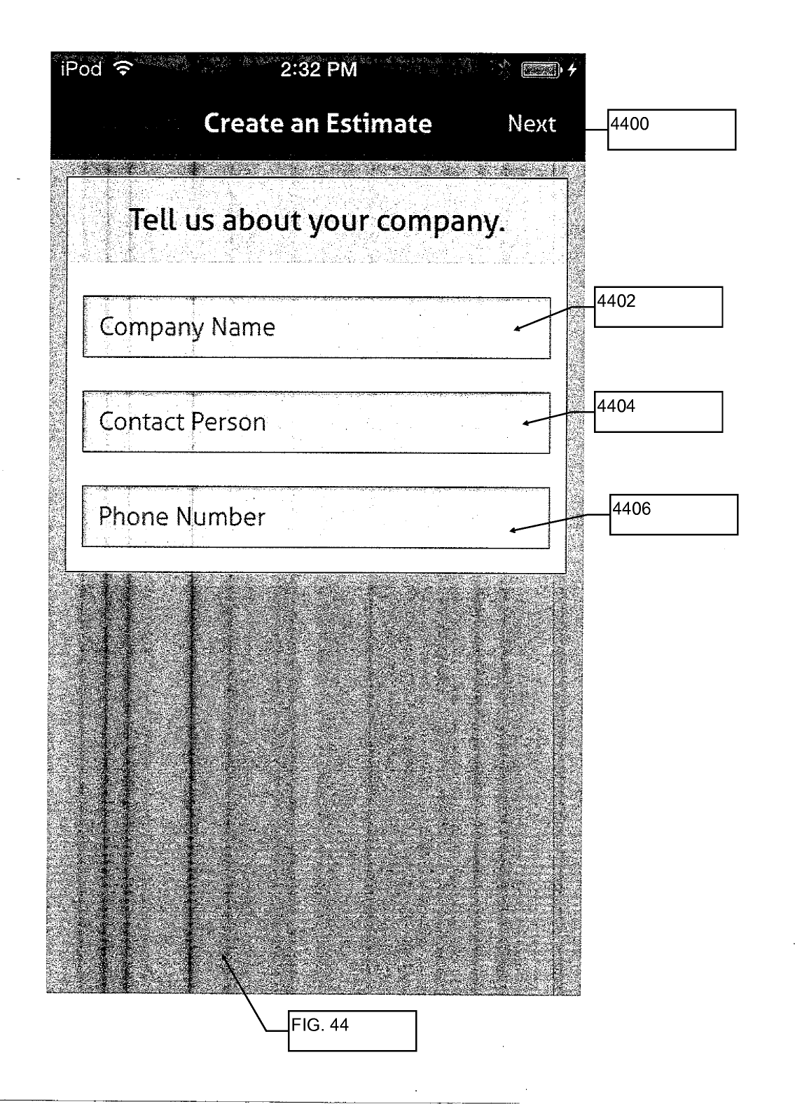

Returning to FIG. 31, upon the consumer indicating that the move in question is a corporate relocation, the consumer is displayed a corporate move information interface 4400 in FIG. 44. In other words, FIG. 44 depicts company information submission interface 4400 of the disclosed invention, where a request is presented to the consumer to specify more information about the move such as a company name 4402, a contact person 4404, and a contact phone number 4406.

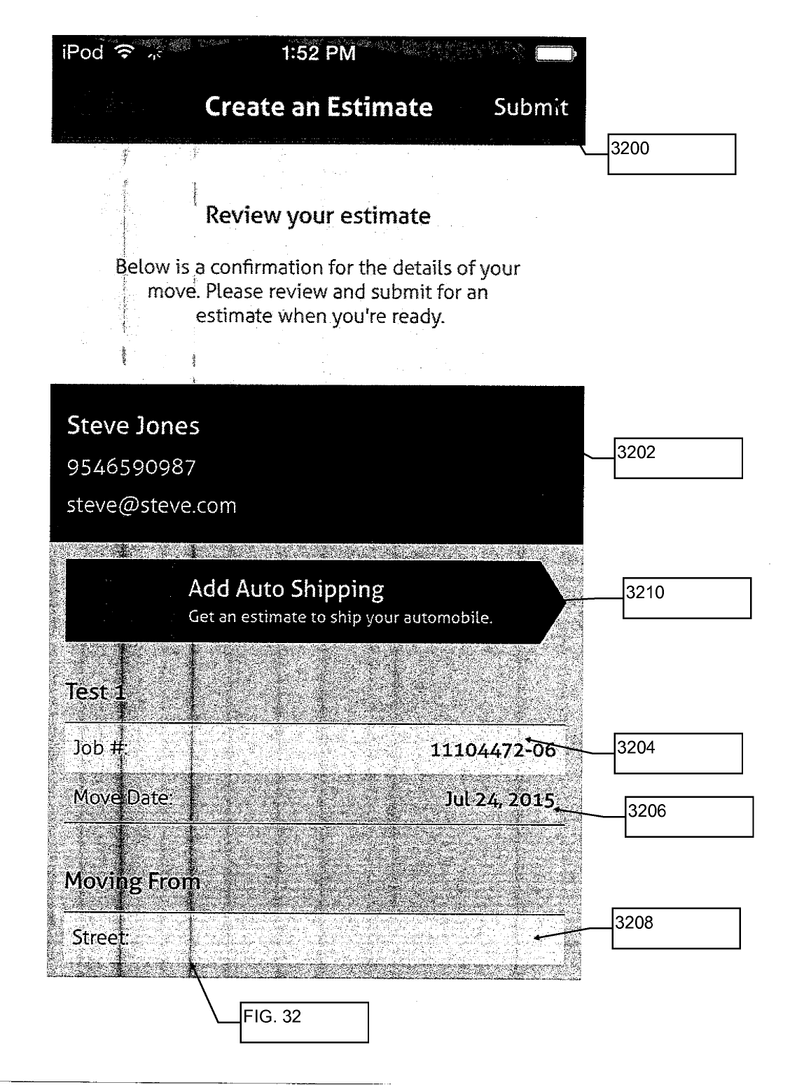

Turning back to FIG. 31, if the consumer indicates that the move is a not corporate relocation by selecting no option 3102 then interface 3200 may be displayed. FIG. 32 shows an estimate review interface 3200 which may display the information submitted by the consumer via the previous pages such as consumer contact information 3202, job id 3204, move date 3206, source address 3208 and the like. Additionally, the system may present add auto shipping query 3210 in an event if the consumer has a car that needs to be shipped from the source location to the destination location. If the consumer decides to add auto shipping then interface 4100 displayed in FIG. 41 may be displayed.

Turning now to FIG. 41, showing auto shipping estimate interface 4100 where consumer can request a quote for shipping an automobile. Automobile information such as automobile manufacturing year 4102, automobile make name 4104, automobile model name 4106, and automobile operable condition 4108 may be provided via interface 4100.

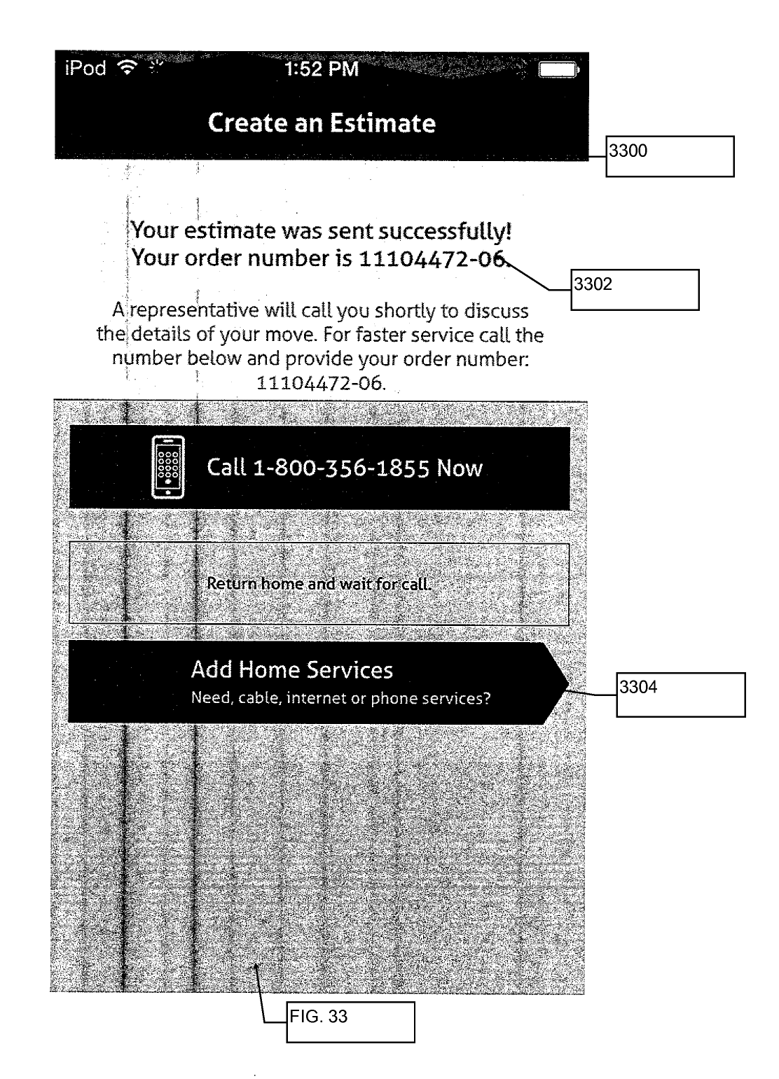

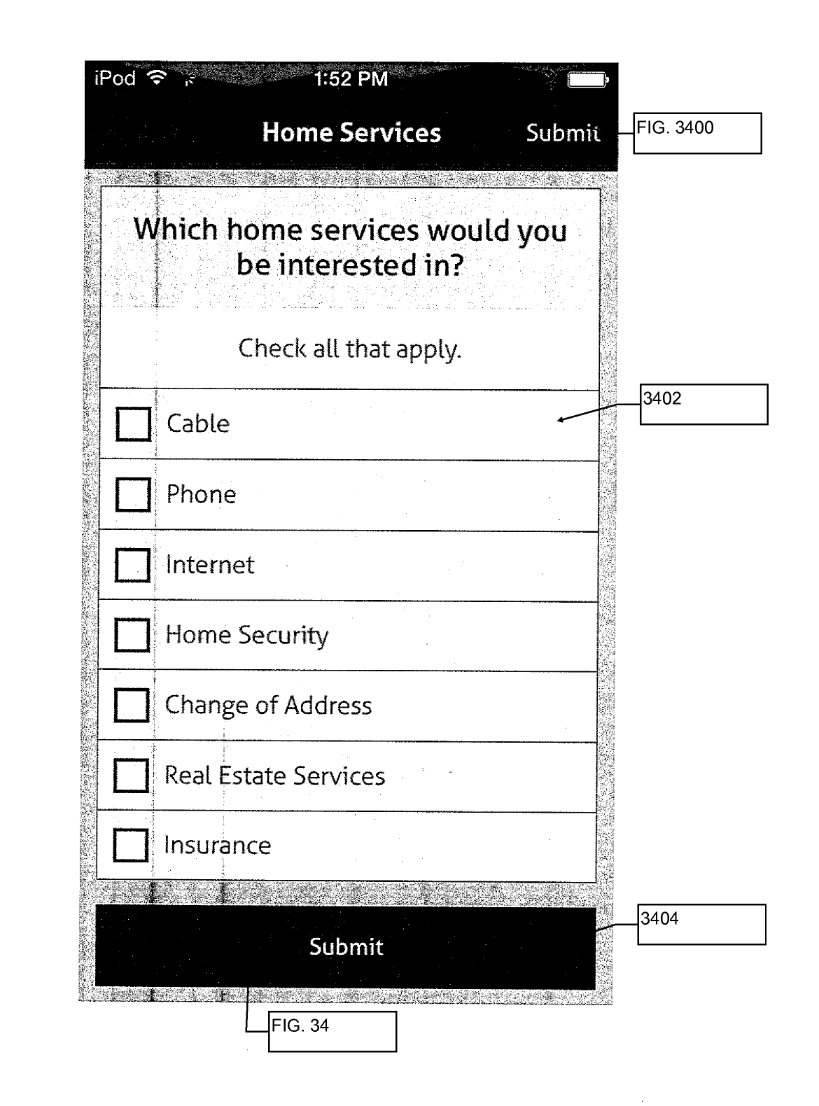

Alternatively, if the consumer decides not to add auto shipping then interface 3300 displayed in FIG. 33 may be displayed. Now referring to FIG. 33 depicting estimation dispatch notification interface 3300 of the disclosed system. The consumer may be presented an indication 3302 stating that your estimate was send successfully. Additionally, an option to add home services 3304 may be presented to the consumer. In the event the consumer selects to add home services, then interface 3400 shown in FIG. 34 may be displayed to the consumer.

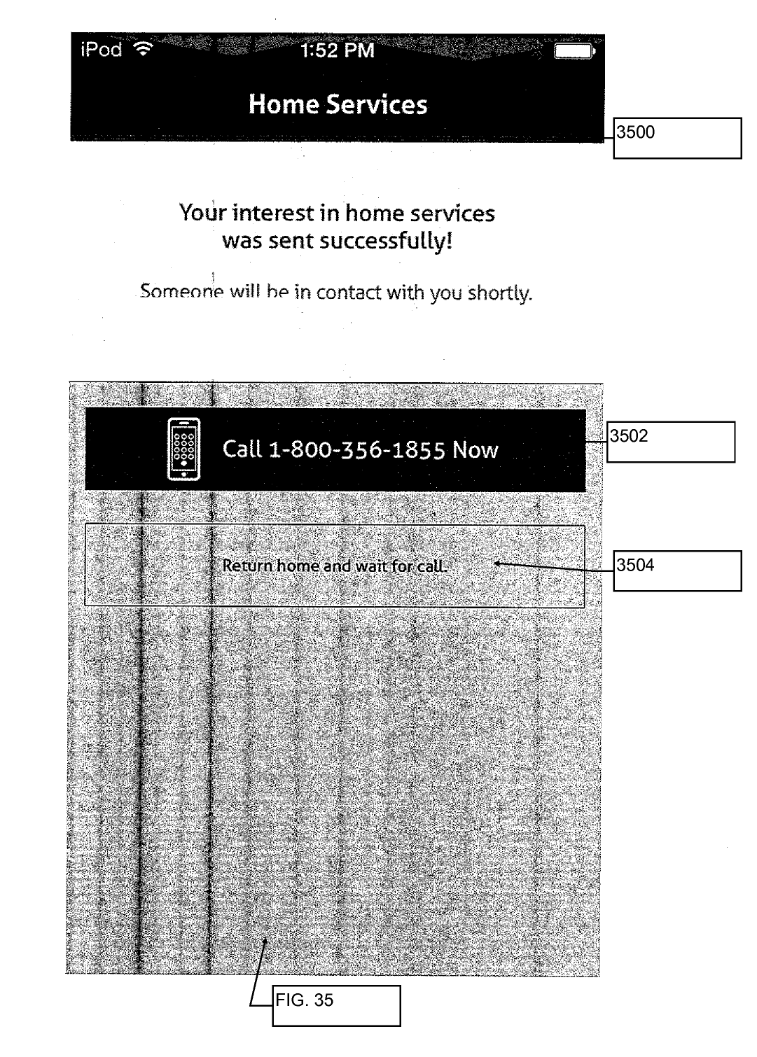

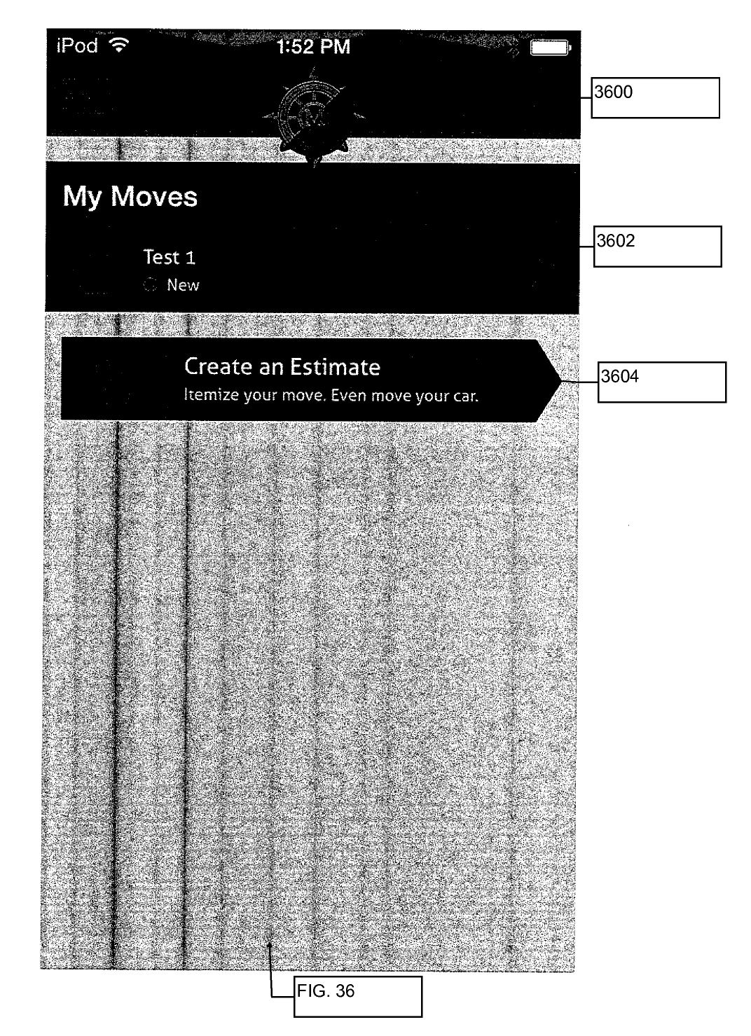

FIG. 34 illustrates home services selection interface 3400 of the disclosed invention. In other words, interface 3400 shown in FIG. 34 enumerates several options presented to the consumer pertaining to home services 3402 that may be needed at destination location. After selecting the home services of interest, the consumer may select submit option 3404 causing the display of interface 3500 shown in FIG. 35. The system may present a home services information submission notification on interface 3500, and display a contact number 3502 they can call to get more information regarding the home services. Optionally by selecting option 3504, the consumer may wait for the system representative to contact the consumer. Upon the consumer selecting either option 3502 or 3504, interface 3600 shown in FIG. 36 may be displayed.

The consumer may select at least one service from a group of services displayed on the interface 3500 such as cable television service, Internet service, phone service, electric service, gas service, home repair service, and home insurance service at the destination location. Notably these are exemplary services, as such many other services like house cleaning service, pet care service, or lawn service may be added to the group of services may be displayed on the interface.

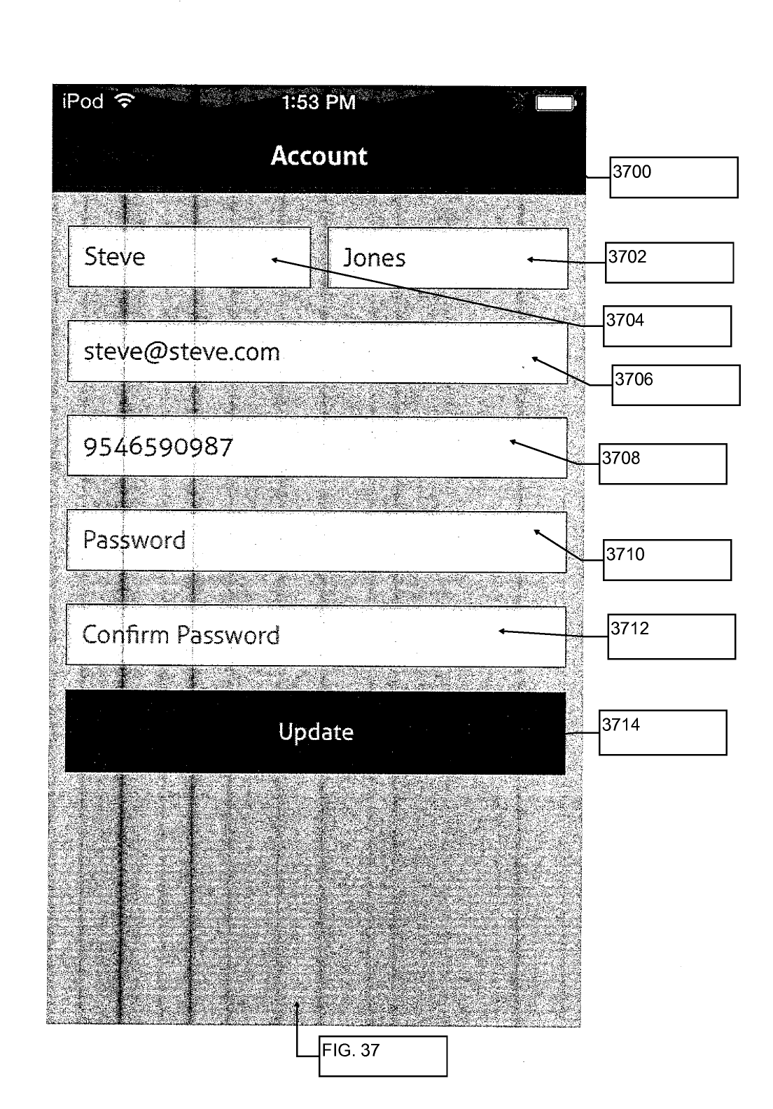

FIG. 36 illustrates an estimate review interface 3600 that may show a list of each estimate 3602 the system has documented for the consumer and present an option 3604 for the consumer to create another estimate. If the consumer selects option 3604, then interface 1300 shown in FIG. 13. Alternatively, if the consumer selects option 3602, then interface 3700 shown in FIG. 37 may be displayed.

FIG. 37 depicts a consumer information update interface 3700 according to a preferred embodiment of the disclosed invention. Thus, several input areas to accept consumer profile change information may be displayed on the interface 3700. For example, by selecting options 3704 and 3702 on the interface 3700, the consumer may change the consumer's first and last name. Likewise, the consumer may change cellular phone number by entering new cellular phone number in the input area 3708. The consumer may change email address by entering an updated email address in the input area 3706. Input areas 3710 and 3712 may be configure to accept consumer password change information. For example, the consumer may enter new password in the input area 3710 on the interface 3700, and the consumer may confirm the new password by entering the new password that was previously entered in the input area 3710 once again in the input area 3712 on the interface 3700. Finally, the consumer may select update option 3714 to update the password information in a remote database configured to store consumer information.

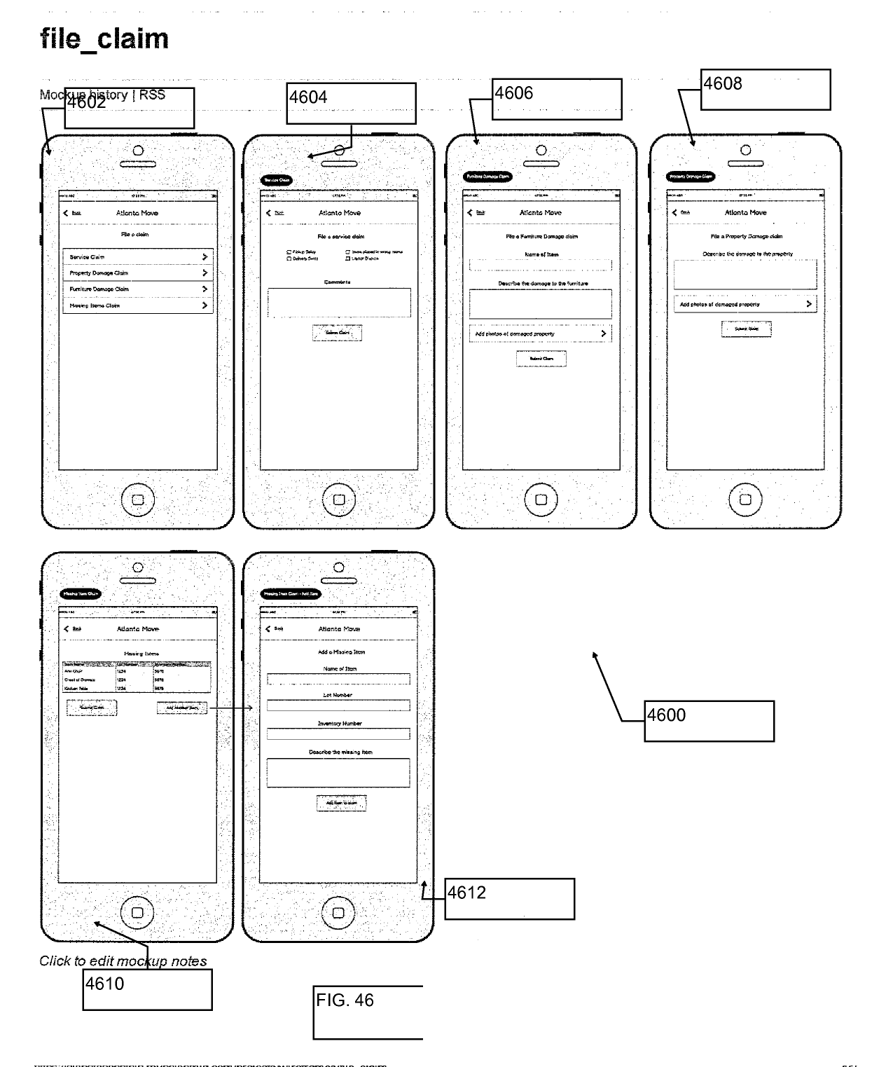

FIG. 46 may illustrate a claim submission interface 4600 whereby the client can submit a specific claim from the client's mobile device and notify the mover. Sub-interface 4602 may display different types of claims the client can file. The client may be able to file a service claim via sub-interface 4604, a furniture damage claim via sub-interface 4606, a property damage claim via sub-interface 4608, a missing items claim via sub-interface 4610, or may add a missing item via sub-interface 4612.

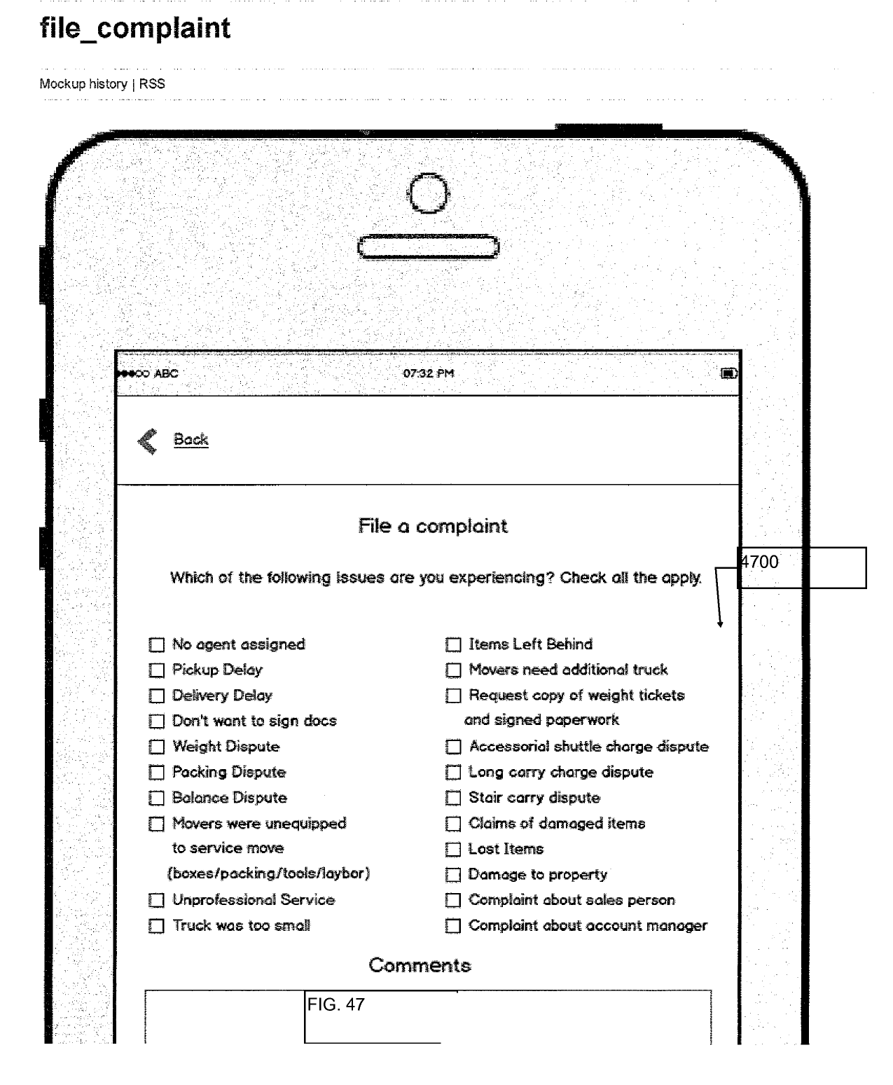

Similarly, as shown in FIG. 47, the client may file a complaint via a claim submission interface 4700. The client can submit complaint from mobile device and notify the mover. The client may select appropriate boxes shown on the interface 4700 to indicate the cause of the complaint such as pickup delay, delivery delay, balance dispute and the like.

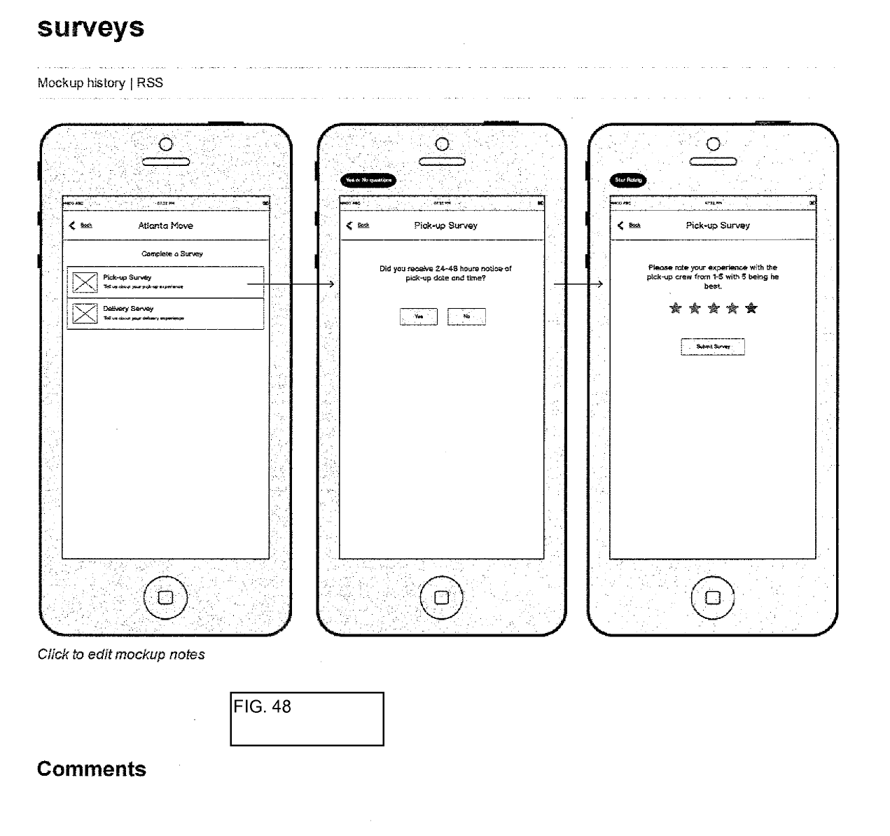

FIG. 48 illustrates a survey submission interface 4800 whereby the client can submit a survey. After a move is completed the client can optionally complete a survey to indicate the client's experience with the moving company. This may provide feedback for the moving company. The client may choose to take either a pickup survey or a delivery survey and answer questions presented on the survey interface such as was the load picked up on time, how would the client rate the move experience, and the like

The foregoing discussion of the preferred embodiments has been provided only by way of introduction. Nothing in this section should be taken as a limitation of the claims, which define the scope of the invention.

1. A method for actuating movement of at least one item from a source location to a destination location, the method comprising:
ascertaining a move initiating entity having a source location;
identifying a first set of components at the source location;
iteratively processing each component in the set of components at the source location by performing the following steps until each component from the set of components is processed:
identifying a next component from the set of components, and
iteratively generating a tag for the next component;
selecting a first set of items from the tagged items at the source location, wherein the first set of items is to be dispatched from the source location to the destination location;
generating a destination layout at the source location via an interface based on an input specifying a desired position of each item in the first set of items at the destination location;
ascertaining a set of distance parameters for the source location and the destination location; and
generating at least one estimate for moving the first set of items from the source location to the destination location after performing a first set of calculations.

2. The method of claim 1, wherein the input specifying the desired position of each item in the first set of items at the destination location is provided by the move initiating entity.

3. The method of claim 1, further comprising the step of generating a source layout indicating the position of each item in the set of items at the source location.

4. The method of claim 3, further comprising the step of generating a three dimensional model of the source layout and a three dimensional model of the destination layout on the interface.

5. The method of claim 4, further comprising the step of selecting an item from the first set of items from the three dimensional model of the source layout and situating the selected item in the three dimensional model of the destination layout.

6. The method of claim 5, further comprising the step of selecting each item from the first set of items from the three dimensional model of the source layout and situating the selected each item in the three dimensional model of the destination layout.

7. The method of claim 6, further comprising the step of mapping the location of each item in the first set of items from the three dimensional model of the source layout to a corresponding location on the three dimensional model of the destination layout, such that each item in the first set of items from the source layout has a corresponding position on the three dimensional model of the destination layout.

8. The method of claim 1, further comprising the step of ascertaining a number of boxes required to accommodate the first set of items.

9. The method of claim 8, further comprising the step of configuring the contents of a given box by grouping items of varying sizes and orientations from the first set of items such that least amount of empty space is left in the given box.

10. The method of claim 8, further comprising the step of connecting at least one consumer service at the destination location upon receiving a request to connect the consumer service from the move initiating entity.

11. The method of claim 10, further comprising the step of transporting a consumer vehicle at the destination location upon receiving a request to transport the consumer vehicle from the move initiating entity.

12. The method of claim 11, further comprising the step of transporting a second set of items from the tagged items from the source location to a storage facility upon receiving a request to transport the second set of items to the storage facility from the move initiating entity.

13. The method of claim 12, wherein the first set of calculations further comprises the step of calculating the distance between the source location and the destination location.

14. The method of claim 13, wherein the first set of calculations further comprises the steps of aggregating the cost of the number of boxes required for packing the tagged items, the cost of packing the tagged items, the cost of moving the tagged items from the source location to the destination location, the cost of transporting the consumer vehicle from the source location to the destination location, and the cost of connecting the services at the destination location.

15. The method of claim 14, wherein the set of distance parameters for the source location comprise the distance between the source location and the source loading zone, and wherein the set of distance parameters for the destination location comprise the distance between the destination location and the destination loading zone.

16. The method of claim 15, further comprising the step of generating at least one estimate based on at least one of the set of distance parameters for the source location, the set of distance parameters for the destination location, and the distance between the source location and the destination location.

17. A system for actuating movement of at least one item from a source location to a destination location, the system comprises:
a control unit configured to ascertain a move initiating entity and identify a first set of components at the source location;
a component processing unit disposed in the control unit, wherein the component processing unit is configured to iteratively process each component in the set of components at the source location until each component from the set of components is processed, the component processing unit comprises:
an identification unit disposed in a component processing unit, wherein the identification unit is configured to identify a next component from the set of components, and
a tag generation unit disposed in a component processing unit, wherein the tag generation unit is configured to iteratively generate a tag for the next component;
a selection unit disposed in the control unit, wherein the selection unit is configured to select a first set of items from the tagged items at the source location, wherein the first set of items is to be dispatched from the source location to the destination location;
a destination layout generation unit disposed in the control unit, wherein the destination layout generation unit is configured to generate a destination layout at the source location via an interface based on an input specifying a desired position of each item in the first set of items at the destination location;
a distance computation unit disposed in the control unit, wherein the distance computation unit is configured to ascertain a set of distance parameters for the source location and the destination location; and
an estimate generation unit disposed in the control unit, wherein the estimate generation unit is configured to generate at least one estimate for moving the first set of items from the source location to the destination location after performing a first set of calculations.

18. The system of claim 17, wherein the input specifying the desired position of each item in the first set of items at the destination location is provided by the move initiating entity.

19. The system of claim 17, further configured to generate a source layout indicating the position of each item in the set of items at the source location.

20. The system of claim 19, further comprises a model generation unit disposed in the control unit configured to generate a three dimensional model of the source layout and a three dimensional model of the destination layout on the interface.

21. The system of claim 20, wherein the destination layout generation unit is further configured to select an item from the first set of items from the three dimensional model of the source layout and situate the selected item in the three dimensional model of the destination layout.

22. The system of claim 20, wherein the destination layout generation unit is further configured to select each item from the first set of items from the three dimensional model of the source layout and situate the selected each item in the three dimensional model of the destination layout.

23. The system of claim 20, wherein the destination layout generation unit is further configured to map the location of each item in the first set of items from the three dimensional model of the source layout to a correspond location on the three dimensional model of the destination layout, such that each item in the first set of items from the source layout has a corresponding position on the three dimensional model of the destination layout.

24. The system of claim 17, further comprises a container content management unit configured to ascertain the number of boxes required to accommodate the first set of items.

25. The system of claim 24, wherein the container content management unit is further configured to define the contents of a given box by grouping items of varying sizes and orientations from the first set of items such that least amount of empty space is left in the given box.

26. The system of claim 24, further comprises a service management unit configured to connect at least one consumer service at the destination location after receiving a request to connect the consumer service from the move initiating entity.

27. The system of claim 26, wherein the service management unit is further configured to transport a consumer vehicle at the destination location after receiving a request to transport the consumer vehicle from the move initiating entity.

28. The system of claim 27, further comprises a dispatch management unit configured to transport the first set of tagged items from the source location to the destination location.

29. The system of claim 28, further comprises a dispatch management unit configured to transport a second set of items from the tagged items from the source location to a storage facility upon receiving a request to transport the second set of items from the move initiating entity.

30. The system of claim 29, wherein the first set of calculations comprise calculating the distance between the source location and the destination location.

31. The system of claim 30, wherein the first set of calculations comprise aggregating the cost of the number of boxes required for packing the tagged items, the cost of packing the tagged items, the cost of moving the tagged items from the source location to the destination location, the cost of transporting the consumer vehicle from the source location to the destination location, and the cost of connecting the services at the destination location.

32. The system of claim 31, wherein the set of distance parameters for the source location comprise the distance between the source location and the source loading zone, and wherein the set of distance parameters for the destination location comprise the distance between the destination location and the destination loading zone.

33. The system of claim 32, wherein the estimate is based on at least one of the set of distance parameters for the source location, the set of distance parameters for the destination location, and the distance between the source location and the destination location.
